(19) United States
(12) Patent Application Publication
(10) Pub. No.: US 2025/0306501 A1
(43) Pub. Date: Oct. 2, 2025

(54) IMAGE FORMING APPARATUS

(71) Applicant: BROTHER KOGYO KABUSHIKI KAISHA, Nagoya (JP)

(72) Inventors: Shuji OTA, Okazaki (JP); Shuya ICHIKAWA, Nagoya (JP)

(73) Assignee: BROTHER KOGYO KABUSHIKI KAISHA, Nagoya (JP)

(21) Appl. No.: 19/065,527

(22) Filed: Feb. 27, 2025

(30) Foreign Application Priority Data
Mar. 26, 2024 (JP) 2024-050293
Mar. 26, 2024 (JP) 2024-050294
Mar. 26, 2024 (JP) 2024-050295
Mar. 26, 2024 (JP) 2024-050296

(51) Int. Cl. G03G 15/08

(52) U.S. Cl. CPC G03G 15/0813; G03G 15/0865

(57) ABSTRACT

An image forming apparatus includes a photosensitive drum, a development cartridge, a motor, a rotating cam and a cam follower. The development cartridge includes a development roller that is movable between a contact position and a spaced position. The motor is rotatable in a forward direction and in a reverse direction. The rotating cam is rotatable in a forward direction and in a reverse direction by a driving force of the motor. The cam follower is configured to move in a direction of a rotation axis of the rotating cam in response to rotation of the rotating cam and to push the development cartridge to move the development roller between the contact position and the spaced position. The rotating cam includes a wall configured to contact the cam follower in a direction of rotation of the rotating cam to restrict the rotation of the rotating cam.

### REFERENCE TO RELATED APPLICATIONS

This application claims priority from Japanese Patent Application Nos. 2024-050293, 2024-050294, 2024-050295, 2024-050296 filed on Mar. 26, 2024. The entire contents of the priority applications are incorporated herein by reference.

### BACKGROUND ART

An image forming apparatus including a cam follower, a rotating cam and a translating plate is known in the art. The cam follower causes a development roller to move relative to a photosensitive drum. The rotating cam causes the cam follower to move. The translating plate is slidable in conjunction with opening and closing of a cover. In such an image forming apparatus, the translating plate slides in response to the cover being opened and causes the rotating cam to rotate within a predetermined angular range. This causes the cam follower to move in one direction so that the development roller comes into contact with the photosensitive drum.

### SUMMARY

In an image forming apparatus known in the art, when the rotating cam rotates to a phase out of the predetermined angular range of the rotating cam, for example, by the translating plate or other external forces, it may not be possible to accurately control the rotating cam.

It would be desirable to restrain the rotating cam from rotating excessively.

In one aspect, an image forming apparatus according to the present disclosure comprises a photosensitive drum, a development cartridge, a motor, a rotating cam, and a cam follower.

The development cartridge comprises a development roller.

The development roller is movable between a contact position in which the development roller is in contact with the photosensitive drum and a spaced position in which the development roller is spaced apart from the photosensitive drum.

The motor is rotatable in a forward direction and in a reverse direction.

The rotating cam is rotatable in a forward direction and in a reverse direction in response to receiving a driving force of the motor.

The cam follower moves in a direction of a rotation axis of the rotating cam in response to rotation of the rotating cam. The cam follower pushes the development cartridge to move the development roller between the contact position and the spaced position.

The rotating cam includes a wall.

The wall contacts the cam follower in a direction of rotation of the rotating cam. The wall restricts the rotation of the rotating cam.

Since the image forming apparatus is configured such that the wall of the rotating cam contacts the cam follower in the direction of rotation of the rotating cam, it is possible to restrict the rotation of the rotating cam and the rotating cam can thereby be restrained from rotating excessively.

The cam follower may be movable between a pushing position in which the cam follower pushes the development cartridge to locate the development roller in the spaced position, and a non-pushing position in which the cam follower locates the development roller in the contact position.

The rotating cam may comprise a first surface, an inclined surface and a second surface.

The first surface locates the cam follower in the non-pushing position.

The inclined surface extends obliquely from the first surface. The inclined surface pushes the cam follower in the direction of the rotation axis away from the first surface to move the cam follower from the non-pushing position to the pushing position.

The second surface retains the cam follower in the pushing position. The second surface is connected to the inclined surface.

The wall may include a first wall protruding from the first surface.

By configuring the image forming apparatus such that the first wall protruding from the first surface contacts the cam follower, the rotating cam can be restrained from rotating excessively in a direction in which the inclined surface moves away from the cam follower located in the non-pushing position.

The wall may include a second wall protruding from the second surface.

By configuring the image forming apparatus such that the second wall protruding from the second surface contacts the cam follower, the rotating cam can be restrained from rotating excessively in a direction in which the inclined surface moves away from the cam follower located in the pushing position; thus, the cam follower can be restrained from falling off the second surface.

The first wall, the first surface, the inclined surface, the second surface and the second wall may be located in this order in the direction of rotation of the rotating cam, and the rotating cam may be rotatable from a position in which the first wall contacts the cam follower to a position in which the second wall contacts the cam follower.

By configuring the image forming apparatus such that the rotating cam is rotatable from a position in which the first wall contacts the cam follower to a position in which the second wall contacts the cam follower, the rotating cam can be rotated within a predetermined range.

The first wall may have a first side surface that contacts the cam follower, the second wall may have a second side surface that contacts the cam follower, and an angle formed by a first straight line connecting the rotation axis of the rotating cam and the first side surface, and a second straight line connecting the rotation axis of the rotating cam and the second side surface may be equal to or smaller than 180 degrees as viewed in the direction of the rotation axis.

By configuring the image forming apparatus such that the angle formed by the first straight line and the second straight line is equal to or smaller than 180 degrees, the rotating cam can be rotated in a space-saving manner.

The motor may rotate in the forward direction during printing, and the cam follower may move in a direction from the second surface toward the first surface by way of the inclined surface relative to the rotating cam in response to rotation of the motor in the forward direction.

The cam follower may move in a direction from the first surface toward the second surface by way of the inclined surface relative to the rotating cam in response to rotation of the motor in the reverse direction.

The cam follower may comprise a slide shaft, an arm and a pin.

The slide shaft is movable in the direction of the rotation axis.

The arm extends from the slide shaft in a direction perpendicular to the direction of the rotation axis.

The pin extends from the arm in the direction of the rotation axis. The pin pushes the development cartridge.

The arm may be contactable with the first wall.

The arm may be contactable with the second wall.

The image forming apparatus may further comprise a spring that biases the cam follower toward the non-pushing position.

The image forming apparatus may further comprise a stopper that restricts the cam follower from rotating in the direction of rotation of the rotating cam.

By configuring the image forming apparatus such that the rotation of the cam follower is restricted by the stopper, the rotating cam can be more reliably restrained by the cam follower from rotating excessively.

The image forming apparatus may further comprise a cover that covers the rotating cam.

The cover may include the stopper.

### BRIEF DESCRIPTION OF DRAWINGS

The above aspects, other advantages and further features will become more apparent by describing in detail illustrative, non-limiting embodiments thereof with reference to the accompanying drawings, in which:

FIG. 1 is an illustration showing an image forming apparatus according to an embodiment.

FIG. 2 is a perspective view of a drawer and development cartridges.

FIGS. 3A and 3B are perspective views of a development cartridge.

FIG. 4 is a schematic view showing a driving force transmission system of the image forming apparatus.

FIG. 5 is an illustration showing gear trains and a metal plate.

FIG. 6 is an illustration showing spacing cams, cam followers, shafts and stoppers.

FIG. 7A is an illustration showing a structure for moving the development cartridge with the development cartridge in a contact position.

FIG. 7B is an illustration showing a structure for moving the development cartridge with the development cartridge in a spaced position.

FIG. 8A is a perspective view of a spacing cam and a cam follower located in a non-pushing position.

FIG. 8B is a side view of the spacing cam and the cam follower located in the non-pushing position.

FIG. 9A is a perspective view of the spacing cam and the cam follower located in a pushing position.

FIG. 9B is a side view of the spacing cam and the cam follower located in the pushing position.

FIG. 10A is a perspective view showing structures of the spacing cam surrounding a rib.

FIG. 10B is a side view showing structures of the spacing cam surrounding the rib.

FIGS. 11A and 11B are perspective views of a gear cover.

FIG. 12A is a section view showing the spacing cam, the cam follower, the gear cover and a spring with the cam follower in the non-pushing position.

FIG. 12B is a section view showing the spacing cam, the cam follower, the gear cover and the spring with the cam follower in the pushing position. FIG. 13 is an illustration showing a development-spacing gear train.

FIG. 14 is a perspective view showing an idle gear, a shaft and a leaf spring.

FIG. 15 is a section view showing the idle gear, the shaft, the leaf spring and the metal plate.

FIG. 16 is an illustration showing a fixing-driving gear train and a nip-pressure-adjusting gear train.

FIG. 17 is an illustration showing the fixing-driving gear train, a first ejection roller gear, an ejection-driving gear train, a second ejection roller gear and a sheet-feeding gear train.

FIG. 18A is an illustration showing a nip pressure adjusting mechanism in which the nip pressure is adjusted to a first nip pressure.

FIG. 18B is an illustration showing the nip pressure adjusting mechanism in which the nip pressure is adjusted to a second nip pressure.

FIG. 19 is an illustration showing the spacing cams and a second slider.

FIG. 20A and 20B are illustrations showing the action of a contact piece when the second slider moves rearward and the contact piece contacts a protrusion of the spacing cam.

FIG. 21 is a flow chart showing an an initial position return process.

### DESCRIPTION

An embodiment of an image forming apparatus will be described in detail referring to the drawings where appropriate.

In this embodiment, as one example, a photosensitive drum 50K corresponds to “first photosensitive drum”, a development cartridge 60K corresponds to “first development cartridge”, a development roller 61K corresponds to “first development roller”, a spacing cam 150K corresponds to “first rotating cam” and a cam follower 170K corresponds to “first cam follower”. Further, a photosensitive drum 50C corresponds to “second photosensitive drum”, a development cartridge 60C corresponds to “second development cartridge”, a development roller 61C corresponds to “second development roller”, a spacing cam 150C corresponds to “second rotating cam” and a cam follower 170C corresponds to “second cam follower”.

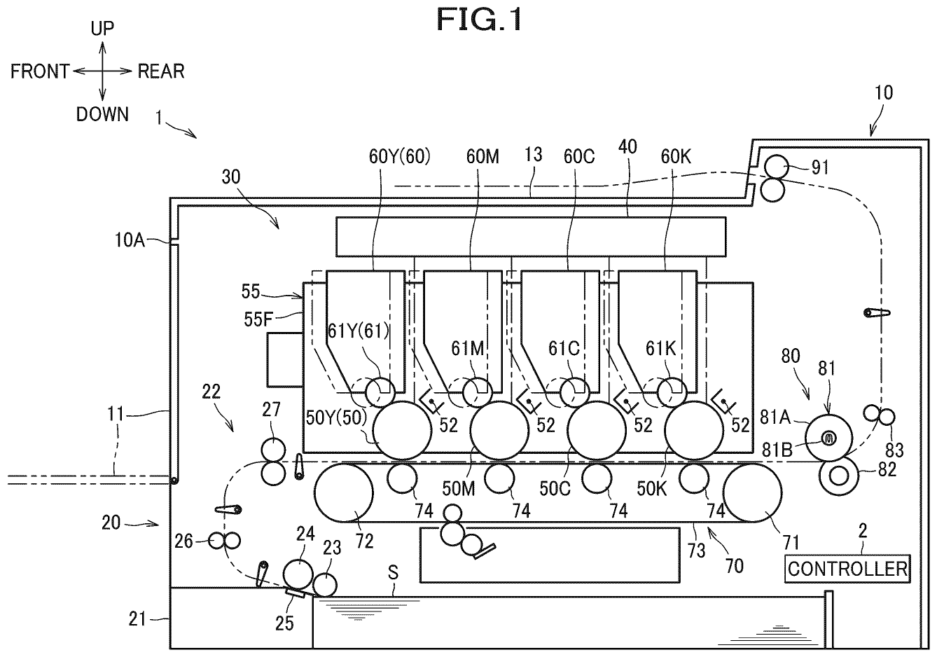

As shown in FIG. 1, the image forming apparatus 1 is a color printer and comprises a housing 10, a front cover 11, a sheet feeder unit 20, an image forming unit 30, a second ejection roller 91 as an ejection roller and a controller 2. In this embodiment, the left side of FIG. 1 is the “front” and the right side of FIG. 1 is the “rear”. The upper side of FIG. 1 is “upward” and the lower side of FIG. 1 is “downward”. Further, the front side of the sheet of FIG. 1 is the “right” and rear side of the sheet of FIG. 1 is the “left”.

The housing 10 has an opening 10A in a front portion thereof. The front cover 11 covers and uncovers the opening 10A. Specifically, the front cover 11 is rotatable relative to the housing 10 between a closed position shown by solid lines and an open position shown by dashed-double dotted lines. The closed position is a position in which the opening 10A is covered, and the open position is a position in which the opening 10A is uncovered.

The sheet feeder unit 20 comprises a sheet tray 21 and a sheet feed mechanism 22. Sheets S are placed in the sheet tray 21. The sheet feed mechanism 22 is a mechanism that receives a driving force to feed the sheets S one by one toward photosensitive drums 50 (50Y, 50M, 50C, 50K), which will be described below, of the image forming apparatus 1. The sheet feed mechanism 22 comprises a pickup roller 23, a separation roller 24, a separation pad 25, a conveyance roller 26 and a registration roller 27.

The sheet feed mechanism 22 picks up sheets S in the sheet tray 21 by the pickup roller 23. Then, the sheet feed mechanism 22 separates the sheets S one from the others between the separation roller 24 and the separation pad 25. Thereafter, the sheet feed mechanism 22 feeds each sheet S toward the image forming unit 30 by the conveyance roller 26 and the registration roller 27.

The image forming unit 30 comprises an exposure unit 40, four photosensitive drums 50, four development cartridges 60, a transfer unit 70, and a fixing device 80.

The exposure unit 40 comprises, for example, a light source, a deflector, lenses and a mirror. The exposure unit 40 emits light beams shown by dashed dotted lines to expose the surfaces of the photosensitive drums 50.

The photosensitive drums 50 include a photosensitive drum 50Y corresponding to yellow, a photosensitive drum 50M corresponding to magenta, a photosensitive drum 50C corresponding to cyan and a photosensitive drum 50K corresponding to the color black. The four photosensitive drums 50 are arranged side by side in the order of photosensitive drum 50Y, photosensitive drum 50M, photosensitive drum 50C and photosensitive drum 50K from upstream toward downstream in a direction of conveyance of the sheet S.

Specifically, the photosensitive drum 50Y is located upstream of the photosensitive drum 50M in the direction of conveyance of the sheet S. The photosensitive drum 50M is located upstream of the photosensitive drum 50C in the direction of conveyance of the sheet S. The photosensitive drum 50C is located upstream of the photosensitive drum 50K in the direction of conveyance of the sheet S.

In the present description and drawings, Y, M, C and K are added to reference characters of parts corresponding to each color to distinguish the color corresponding to each part, and are not added to the reference characters when it is not necessary to distinguish the color corresponding to each part.

The image forming apparatus 1 further comprises a drawer 55. The drawer 55 is movable between an inside position and an outside position through the opening 10A of the housing 10 in a direction in which the photosensitive drums 50 are arranged side by side. The inside position is a position in which the drawer 55 is accommodated in the housing 10, and the outside position is a position in which at least a part of the drawer 55 is exposed to the outside of the housing 10. In this embodiment, the outside position is a position in which the drawer 55 is drawn out forward from the inside position. In this embodiment, the drawer 55 is installable into and removable from the housing 10.

The drawer 55 comprises a frame 55F. The frame 55F supports the four photosensitive drums 50 (50Y, 50M, 50C, 50K) in a manner that allows the photosensitive drums 50 to rotate. The frame 55F supports four chargers 52. Each charger 52 charges a surface of a corresponding photosensitive drum 50.

The development cartridges 60 include a development cartridge 60Y containing yellow toner, a development cartridge 60M containing magenta toner, a development cartridge 60C containing cyan toner and a development cartridge 60K containing black toner. The development cartridge 60Y comprises a development roller 61Y for supplying yellow toner to the photosensitive drum 50Y. The development cartridge 60M comprises a development roller 61M for supplying magenta toner to the photosensitive drum 50M. The development cartridge 60C comprises a development roller 61C for supplying cyan toner to the photosensitive drum 50C. The development cartridge 60K comprises a development roller 61K for supplying black toner to the photosensitive drum 50K.

The development roller 61Y is movable relative to the photosensitive drum 50Y between a contact position in which the development roller 61Y contacts the photosensitive drum 50Y, and a spaced position in which the development roller 61Y is spaced apart from the photosensitive drum 50Y. The development roller 61M is movable relative to the photosensitive drum 50M between a contact position in which the development roller 61M contacts the photosensitive drum 50M, and a spaced position in which the development roller 61M is spaced apart from the photosensitive drum 50M. The development roller 61C is movable relative to the photosensitive drum 50C between a contact position in which the development roller 61C contacts the photosensitive drum 50C, and a spaced position in which the development roller 61C is spaced apart from the photosensitive drum 50C. The development roller 61K is movable relative to the photosensitive drum 50K between a contact position in which the development roller 61K contacts the photosensitive drum 50K, and a spaced position in which the development roller 61K is spaced apart from the photosensitive drum 50K.

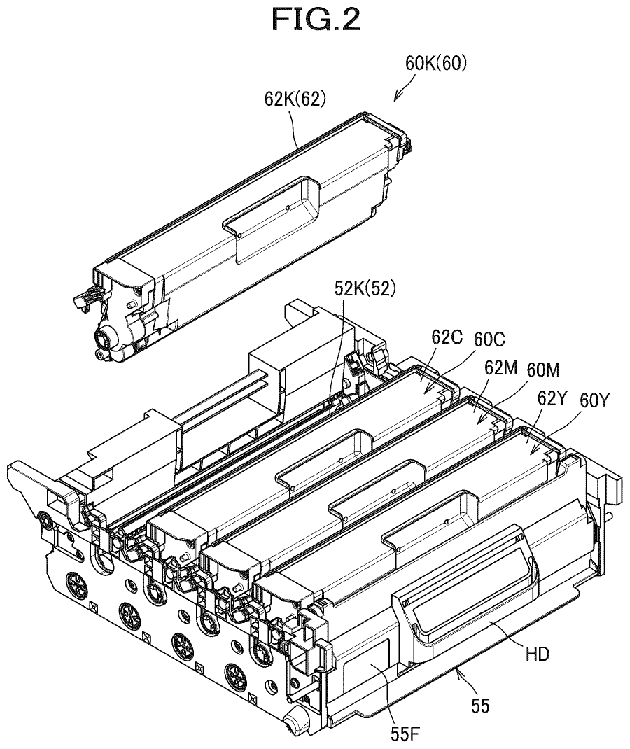

As shown in FIG. 2, the frame 55F of the drawer 55 supports the development cartridges 60 (60Y, 60M, 60C, 60K) in a manner that allows the development cartridges 60 to be installed into and removed from the drawer 55. The development cartridges 60 are replaceable in a state where the drawer 55 is located in the outside position or removed from the housing 10.

The drawer 55 comprises a handle HD. The handle HD is grasped by a user when the drawer 55 is to be moved.

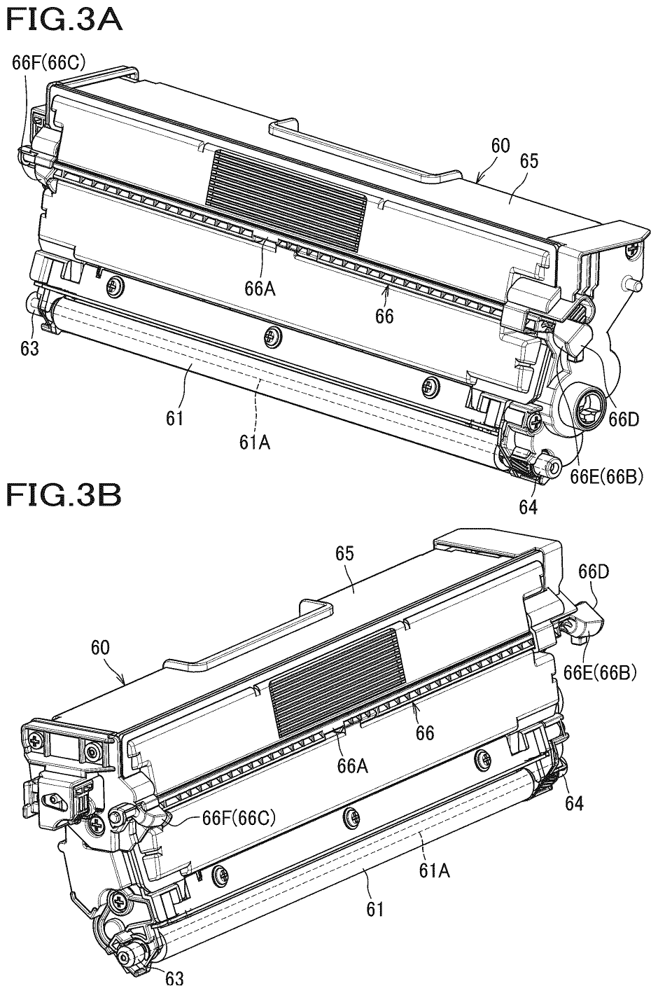

As shown in FIGS. 3A and 3B, each development cartridge 60 further comprises a first collar 63, a second collar 64, a case 65 for containing toner, and a spacing shaft 66.

Each development roller 61 comprises a development shaft 61A. The development shaft 61A extends in an axial direction.

The first collar 63 covers an end of the development shaft 61A. The first collar 63 is shaped as a hollow cylinder. The first collar 63 is guided to lead the development cartridge 60 to an installation position when the development cartridge 60 is being installed into the drawer 55.

The second collar 64 covers the other end of the development shaft 61A. The second collar 64 is shaped as a hollow cylinder. The second collar 64 is guided to lead the development cartridge 60 to the installation position when the development cartridge 60 is being installed into the drawer 55.

The spacing shaft 66 is a member that moves the development roller 61 from the contact position to the spaced position. The spacing shaft 66 is held by the case 65. The spacing shaft 66 comprises a shaft 66A. The shaft 66A is fitted in a groove formed in an outer surface of the case 65. The spacing shaft 66 is thereby held by the case 65 in a manner slidable in the axial direction relative to the case 65.

The shaft 66A extends in the axial direction. The shaft 66A extends from one end to the other end of the case 65. The detailed structure of the spacing shaft 66 will be described later.

As shown in FIG. 1, each development cartridge 60 is supported on the frame 55F in such a manner that it is movable forward and rearward between a first position shown by solid lines and a second position shown by dashed-double dotted lines. The first position is a position in which the corresponding development roller 61 is located in the contact position, and the second position is a position in which the corresponding development roller 61 is located in the spaced position.

Specifically, the development cartridge 60Y is movable relative to the photosensitive drum 50Y between the first position in which the development roller 61Y is located in the contact position and the second position in which the development roller 61Y is located in the spaced position. In other words, the development cartridge 60Y is movable relative to the photosensitive drum 50Y between the first position in which the development roller 61Y contacts the photosensitive drum 50Y and the second position in which the development roller 61Y is spaced apart from the photosensitive drum 50Y.

The development cartridge 60M is movable relative to the photosensitive drum 50M between the first position in which the development roller 61M is located in the contact position and the second position in which the development roller 61M is located in the spaced position. In other words, the development cartridge 60M is movable relative to the photosensitive drum 50M between the first position in which the development roller 61M contacts the photosensitive drum 50M and the second position in which the development roller 61M is spaced apart from the photosensitive drum 50M.

The development cartridge 60C is movable relative to the photosensitive drum 50C between the first position in which the development roller 61C is located in the contact position and the second position in which the development roller 61C is located in the spaced position. In other words, the development cartridge 60C is movable relative to the photosensitive drum 50C between the first position in which the development roller 61C contacts the photosensitive drum 50C and the second position in which the development roller 61C is spaced apart from the photosensitive drum 50C.

The development cartridge 60K is movable relative to the photosensitive drum 50K between the first position in which the development roller 61K is located in the contact position and the second position in which the development roller 61K is located in the spaced position. In other words, the development cartridge 60K is movable relative to the photosensitive drum 50K between the first position in which the development roller 61K contacts the photosensitive drum 50K and the second position in which the development roller 61K is spaced apart from the photosensitive drum 50K.

The transfer unit 70 comprises a drive roller 71, a follower roller 72, an endless conveyor belt 73, and four transfer rollers 74. The conveyor belt 73 is looped around the drive roller 71 and the follower roller 72. An outside surface of the conveyor belt 73 is in contact with the four photosensitive drums 50. Each of the transfer rollers 74 is positioned to face an inside surface of the conveyor belt 73 and nip the transfer belt 73 in combination with the corresponding photosensitive drum 50.

The fixing device 80 fixes a toner image, transferred onto the sheet S, on the sheet S. The fixing device 80 comprises a heating member 81, a pressure member 82 and a first ejection roller 83 as the ejection roller. The heating member 81 comprises a heating roller 81A and a heater 81B. The heating roller 81A is a hollow cylindrical roller made of metal. The heater 81B is provided to heat the heating roller 81A and is arranged to extend inside the heating roller 81A.

The pressure member 82 nips the sheet S in combination with the heating member 81. Specifically, the pressure member 82 is a pressure roller that nips the sheet S in combination with the heating roller 81A. The pressure roller is a roller comprising a metal core covered with a rubber layer. The fixing device 80 receives a driving force to convey the sheet S between the heating roller 81A of the heating member 81 and the pressure member 82 (pressure roller). Further, the fixing device 80 receives a driving force to convey the sheet S by the first ejection roller 83.

The image forming unit 30 uniformly charges the surfaces of the photosensitive drums 50 by the chargers 52, and then exposes the surfaces of the photosensitive drums 50 by light beams emitted from the exposure unit 40. As a result, the image forming unit 30 forms electrostatic latent images on the photosensitive drums 50 based on image data. Thereafter, the image forming unit 30 supplies toner contained in the development cartridges 60 from the development rollers 61 located in the contact position to the corresponding photosensitive drums 50. The image forming unit 30 thereby forms toner images on the photosensitive drums 50.

The image forming unit 30 conveys a sheet S fed from the sheet feeder unit 20 through between the photosensitive drums 50 and the transfer rollers 74 to thereby transfer the toner images formed on the photosensitive drums 50 onto the sheet S. Then, the image forming unit 30 conveys the sheet S on which the toner images are transferred through between the heating roller 81A and the pressure member 82 to thereby fix the toner images on the sheet S.

The first ejection roller 83 and the second ejection roller 91 receive a driving force to eject the sheet S from between the heating member 81 and the pressure member 82 to the outside of the housing 10. Specifically, the first ejection roller 83 and the second ejection roller 91 eject the sheet S on which the toner images are fixed onto an output tray 13.

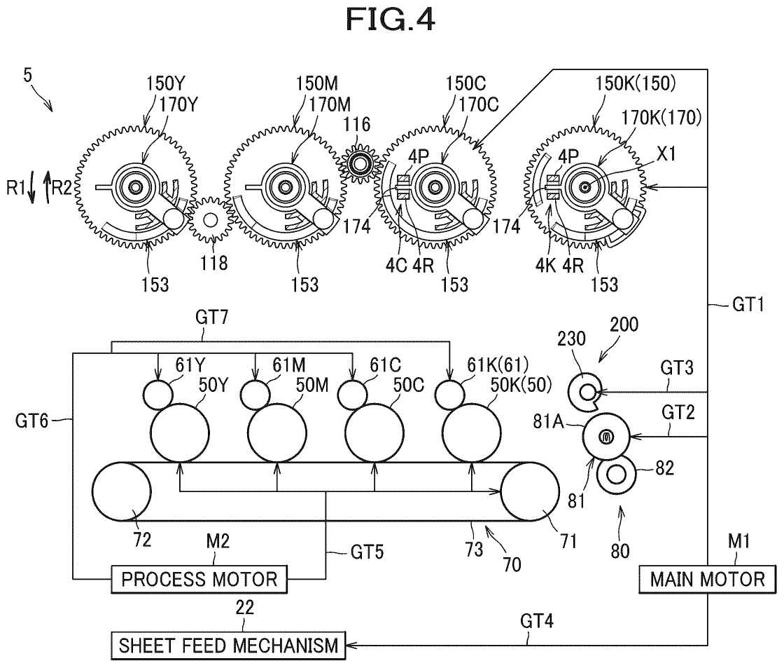

As shown in FIG. 4, the image forming apparatus 1 further comprises a main motor M1 as an example of a motor, a process motor M2, a spacing mechanism 5 and a nip pressure adjusting mechanism 200.

The main motor M1 is a motor for driving spacing cams 150 of the spacing mechanism 5, the fixing device 80, the nip pressure adjusting mechanism 200 and the sheet feed mechanism 22. In other words, the spacing cams 150 of the spacing mechanism 5, the fixing device 80, the nip pressure adjusting mechanism 200 and the sheet feed mechanism 22 receive driving forces from the main motor M1. The main motor M1 is rotatable in a forward direction and a reverse direction. The main motor M1 rotates in the forward direction to convey the sheet S from the sheet tray 21 toward the output tray 13 during printing in which an image is formed on the sheet S.

The process motor M2 is a motor for driving the photosensitive drums 50, the development rollers 61 and the transfer unit 70. In other words, the photosensitive drums 50, the development rollers 61 and the transfer unit 70 receive driving forces from the process motor M2.

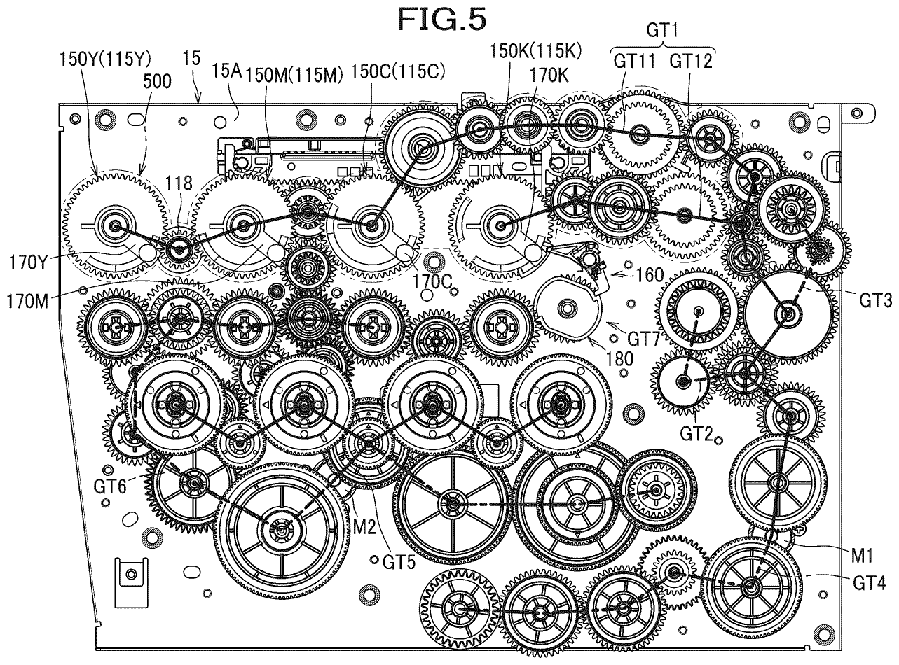

As shown in FIGS. 4 and 5, the image forming apparatus 1 further comprises a development-spacing gear train GT1 as an example of a gear train, a fixing-driving gear train GT2, a nip-pressure-adjusting gear train GT3, a sheet-feeding gear train GT4, a drum-driving gear train GT5, a first development-driving gear train GT6 and a second development-driving gear train GT7.

The development-spacing gear train GT1 transmits a driving force of the main motor M1 to the spacing cams 150 (150Y, 150M, 150C, 150K) of the spacing mechanism 5. The spacing cams 150 are an example of a rotating cam. The development-spacing gear train GT1 connects the main motor M1 and the spacing cams 150.

The fixing-driving gear train GT2 receives a driving force of the main motor M1 from the development-spacing gear train GT1 and transmits the driving force to the fixing device 80. Specifically, the fixing-driving gear train GT2 receives the driving force of the main motor M1 from the development-spacing gear train GT1 and transmits the driving force to the heating roller 81A.

The nip-pressure-adjusting gear train GT3 receives a driving force of the main motor M1 from the development-spacing gear train GT1 and transmits the driving force to a nip pressure adjusting cam 230 of the nip pressure adjusting mechanism 200.

The sheet-feeding gear train GT4 transmits a driving force of the main motor M1 to the sheet feed mechanism 22.

The drum-driving gear train GT5 transmits a driving force of the process motor M2 to the photosensitive drums 50 (50Y, 50M, 50C, 50K).

The first development-driving gear train GT6 transmits a driving force of the process motor M2 to the development rollers 61Y, 61M, 61C.

The second development-driving gear train GT7 transmits a driving force of the process motor M2 to the development roller 61K. Specifically, the second development-driving gear train GT7 receives a driving force of the process motor M2 from the first development-driving gear train GT6 and transmits the driving force to the development roller 61K.

The spacing mechanism 5 receives a driving force from the main motor M1 and moves each of the development rollers 61 between the contact position and the spaced position. The spacing mechanism 5 comprises four spacing cams 150 and four cam followers 170.

The spacing cams 150 are rotatable in a forward direction and a reverse direction upon receiving the driving force from the main motor M1. The spacing cams 150 include a spacing cam 150Y, a spacing cam 150M, a spacing cam 150C and a spacing cam 150K.

The spacing cam 150Y rotates upon receiving a driving force from the main motor M1 and thereby moves the development roller 61Y between the contact position and the spaced position. Specifically, the spacing cam 150Y rotates to move the development cartridge 60Y between the first position and the second position and thereby moves the development roller 61Y between the contact position and the spaced position.

The spacing cam 150M rotates upon receiving a driving force from the main motor M1 and thereby moves the development roller 61M between the contact position and the spaced position. Specifically, the spacing cam 150M rotates to move the development cartridge 60M between the first position and the second position and thereby moves the development roller 61M between the contact position and the spaced position.

The spacing cam 150C rotates upon receiving a driving force from the main motor M1 and thereby moves the development roller 61C between the contact position and the spaced position. Specifically, the spacing cam 150C rotates to move the development cartridge 60C between the first position and the second position and thereby moves the development roller 61C between the contact position and the spaced position.

The spacing cam 150K rotates upon receiving a driving force from the main motor M1 and thereby moves the development roller 61K between the contact position and the spaced position. Specifically, the spacing cam 150K rotates to move the development cartridge 60K between the first position and the second position and thereby moves the development roller 61K between the contact position and the spaced position.

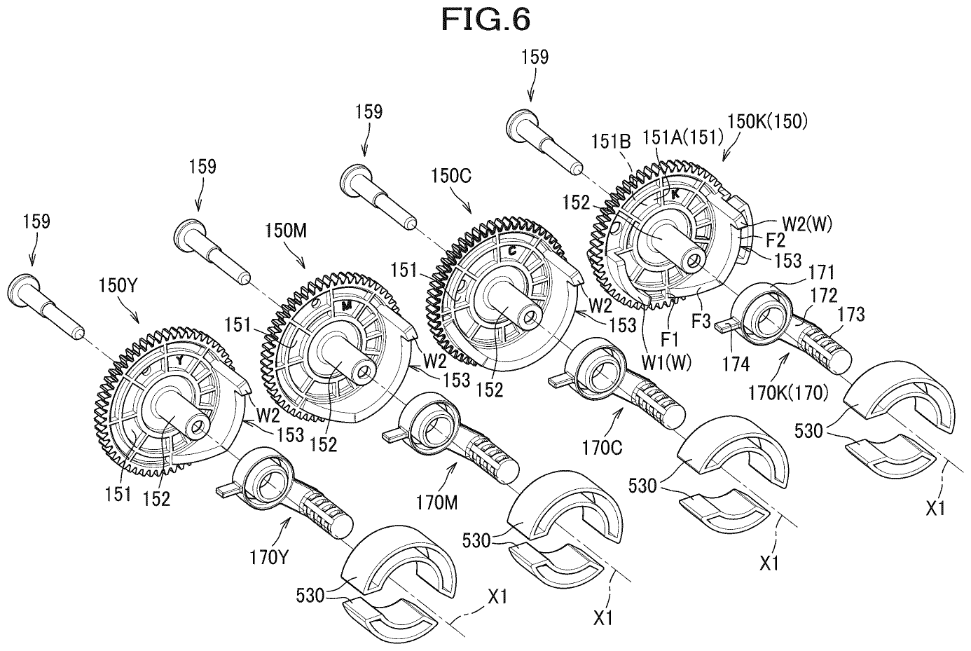

As shown in FIG. 6, the cam followers 170 include a cam follower 170Y, a cam follower 170M, a cam follower 170C and a cam follower 170K. The cam followers 170 are slidable in a direction of rotation axes of the spacing cams 150. The direction of the rotation axes of the spacing cams 150 is the direction in which dashed dotted lines extend in FIG. 6. The direction in which the rotation axes of the spacing cams 150 extend is also referred to simply as “rotation axis direction” in the following description. The rotation axis direction is also the direction in which the rotation axes of the cam gears 115 (115Y, 115M, 115C, 115K) which will be described below extend.

The cam follower 170Y is slidable in the rotation axis direction in response to rotation of the spacing cam 150Y (cam gear 115Y) between a pushing position and a non-pushing position. The pushing position of the cam follower 170Y is a position in which the cam follower 170Y pushes the development cartridge 60Y to locate the development cartridge 60Y in the second position, and the non-pushing position of the cam follower 170Y is a position in which the cam follower 170Y locates the development cartridge 60Y in the first position.

The cam follower 170M is slidable in the rotation axis direction in response to rotation of the spacing cam 150M (cam gear 115M) between a pushing position and a non- pushing position. The pushing position of the cam follower 170M is a position in which the cam follower 170M pushes the development cartridge 60M to locate the development cartridge 60M in the second position, and the non-pushing position of the cam follower 170M is a position in which the cam follower 170M locates the development cartridge 60M in the first position.

The cam follower 170C is slidable in the rotation axis direction in response to rotation of the spacing cam 150C (cam gear 115C) between a pushing position and a non-pushing position. The pushing position of the cam follower 170C is a position in which the cam follower 170C pushes the development cartridge 60C to locate the development cartridge 60C in the second position, and the non-pushing position of the cam follower 170C is a position in which the cam follower 170C locates the development cartridge 60C in the first position.

The cam follower 170K is slidable in the rotation axis direction in response to rotation of the spacing cam 150K (cam gear 115K) between a pushing position and a non-pushing position. The pushing position of the cam follower 170K is a position in which the cam follower 170K pushes the development cartridge 60K to locate the development cartridge 60K in the second position, and the non-pushing position of the cam follower 170K is a position in which the cam follower 170K locates the development cartridge 60K in the first position.

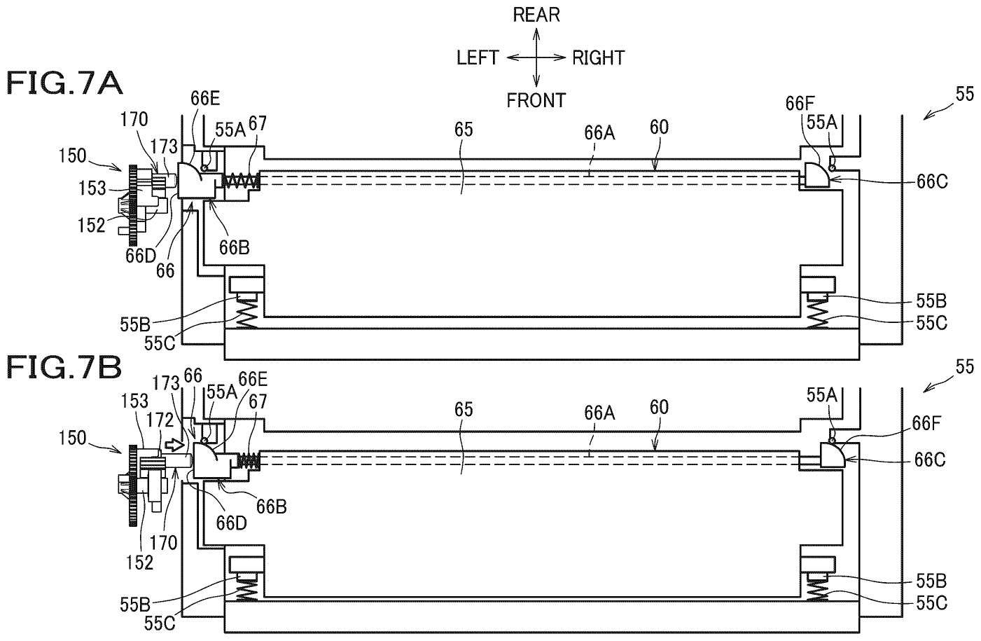

As shown in FIG. 7A, the drawer 55 comprises to-be-contacted portions 55A, pushing members 55B and springs 55C. The to-be contacted portions 55A are portions contacted by the spacing shaft 66 and are each comprised of a roller rotatable about an axis extending along the up-down direction. The pushing members 55B are biased rearward by the spring 55C. When the development cartridge 60 is installed in the drawer 55, the pushing members 55B push the development cartridge 60 rearward by biasing forces of the springs 55C. This causes the development cartridge 60 to move to the first position in which the development roller 61 contacts the photosensitive drum 50.

The spacing shaft 66 slides in the rotation axis direction when it is pushed by the cam follower 170. The spacing shaft 66 comprises a shaft 66A, a first contact member 66B and a second contact member 66C. The shaft 66A is supported by the case 65 in such a manner that the shaft 66A is slidable in the rotation axis direction. The first contact member 66B is fixed on one end of the shaft 66A, and the second contact member 66C is fixed on the other end of the shaft 66A.

The first contact member 66B has a to-be-pushed surface 66D and an inclined surface 66E. The second contact member 66C has an inclined surface 66F. The to-be-pushed surface 66D is a surface to be pushed by the cam follower 170. The inclined surfaces 66E, 66F are surfaces inclined with respect to the left-right direction. As shown in FIG. 7B, when the spacing shaft 66 is pushed by the cam follower 170, the inclined surfaces 66E, 66F contact the to-be-contacted portions 55A and move the development cartridge 60 forward. This causes the development cartridge 60 to move to the second position in which the development roller 61 is spaced apart from the photosensitive drum 50. A spring 67 is located between the first contact member 66B and the case 65. The spring 67 biases the spacing shaft 66 toward the left.

As shown in FIG. 6, the spacing cams 150 are end cams. Each spacing cam 150 comprises a disc portion 151 as an example of a base portion, a boss 152 and a cam portion 153. The disc portion 151 has a first base surface 151A and a second base surface 151B.

The first base surface 151A is a surface of the disc portion 151 that faces the cam follower 170. Although the first base surface 151A is provided with recesses and protrusions formed by a plurality of ribs in the present embodiment, the first base surface 151A may be a flat surface. The first base surface 151A is perpendicular to the rotation axis direction.

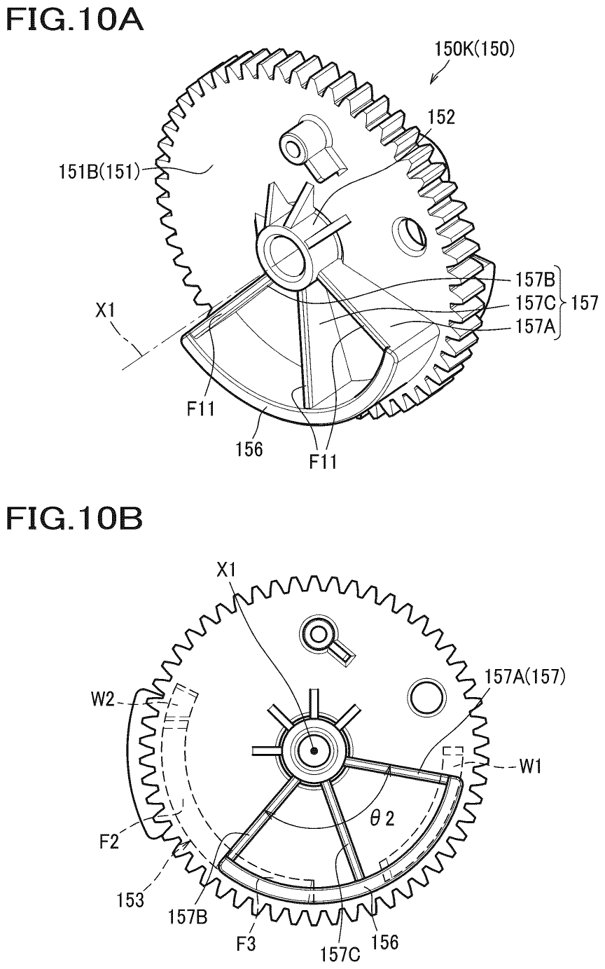

The second base surface 151B is a surface of the disc portion 151 opposite to the first base surface 151A in the rotation axis direction. Although the second base surface 151B is a flat surface in the present embodiment (see FIGS. 10A and 10B), the second base surface 151B may be provided with recesses and protrusions. The second base surface 151B is perpendicular to the rotation axis direction.

The boss 152 extends from the center of the disc portion 151 in the rotation axis direction. The boss 152 is shaped as a hollow cylinder.

The cam portion 153 is configured to move the cam follower 170 in the rotation axis direction. The cam portion 153 protrudes from the disc portion 151 in the rotation axis direction. Specifically, the cam portion 153 protrudes from the disc portion 151 toward one side in the rotation axis direction. The cam portion 153 protrudes from the first base surface 151A of the disc portion 151. The cam portion 153 has an arcuate shape with a center on a rotation axis of the spacing cam 150. In the present embodiment, a length of each cam portion 153 in the rotation direction of the spacing cam 150 is different for each color; however, the length of the cam portion 153 may be the same for each color.

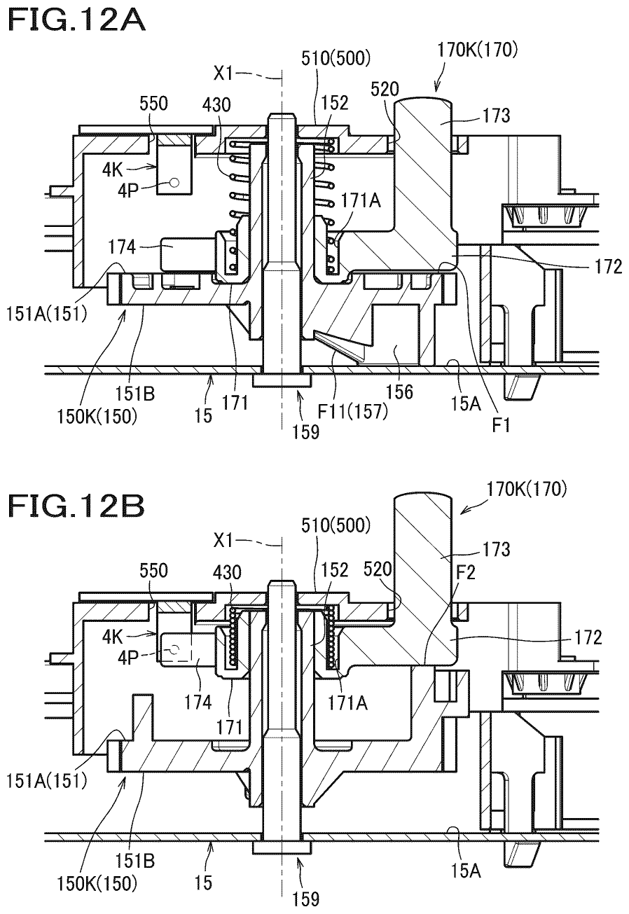

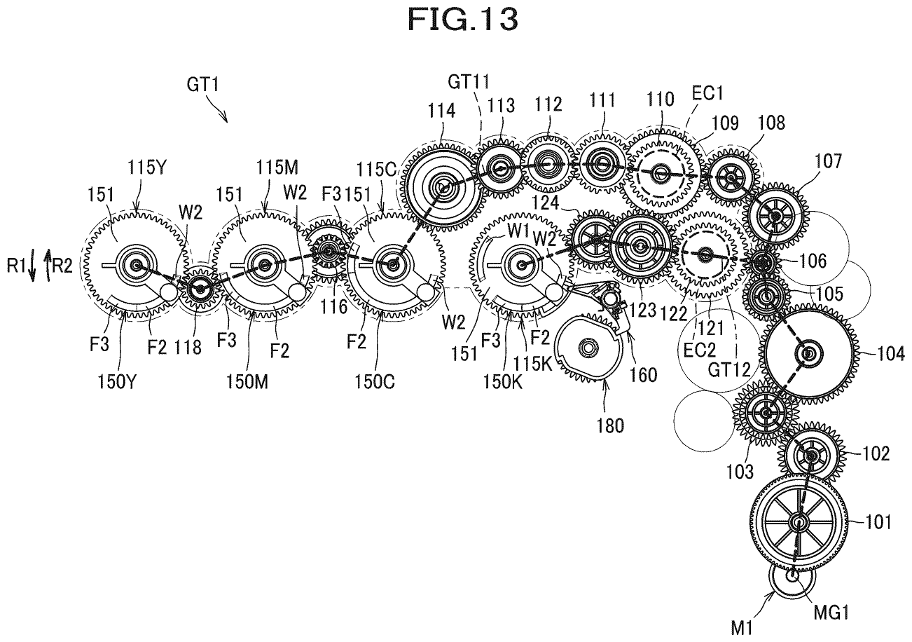

The first base surface 151A has a first surface F1 for locating the cam follower 170 in the non-pushing position. The first surface F1 is a part of the first base surface 151A. As shown in FIG. 12A, when the cam follower 170 is in the non-pushing position, the first surface F1 is opposed to an arm 172 of the cam follower 170 in the rotation axis direction. The arm 172 will be described later. In the present embodiment, the first surface F1 is spaced apart from the arm 172 when the cam follower 170 is in the non-pushing position; however, the first surface F1 may contact the arm 172 when the cam follower 170 is in the non-pushing position.

Referring back to FIG. 6, the cam portion 153 has a second surface F2 and an inclined surface F3.

The second surface F2 is a surface for retaining the cam follower 170 in the pushing position. The second surface F2 is approximately parallel to a plane that is perpendicular to the rotation axis of the spacing cam 150 (cam gear 115).

The inclined surface F3 is a surface for guiding the cam follower 170 between the pushing position and the non-pushing position. The inclined surface F3 pushes the cam follower 170 in a direction away from the first surface F1 in the rotation axis direction to move the cam follower 170 from the non-pushing position to the pushing position. The inclined surface F3 is inclined relative to a plane that is perpendicular to the rotation axis of the spacing cam 150 (cam gear 115). The inclined surface F3 extends obliquely from the first surface F1 toward the one side in the rotation axis direction. Specifically, the inclined surface F3 is inclined in such a manner that the closer to the second surface F2 in a direction of rotation of the spacing cam 150, the farther from the first surface F1.

The inclined surface F3 is located between the first surface F1 and the second surface F2 in the direction of rotation of the spacing cam 150. The second surface F2 is connected to the inclined surface F3.

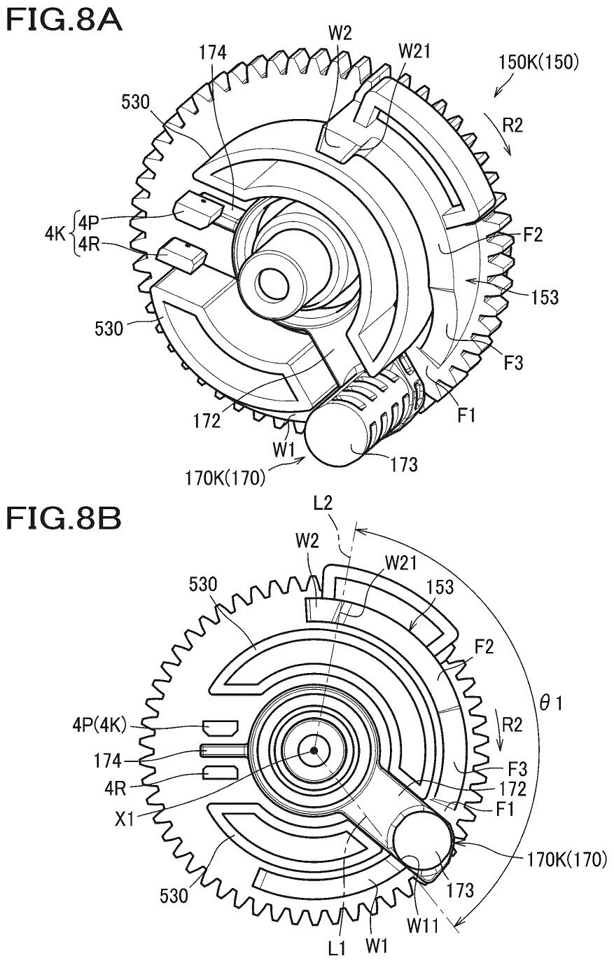

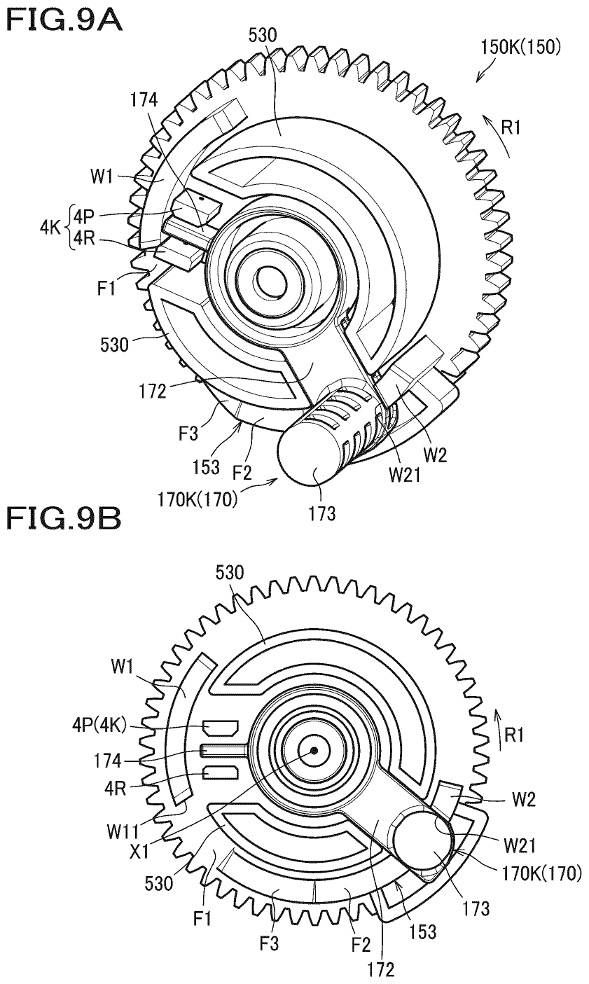

As shown in FIGS. 9A and 9B, the inclined surface F3 causes the cam follower 170 to move from the pushing position to the non-pushing position when the spacing cam 150 rotates in a first direction of rotation R1, which will be referred to as “first rotation direction” in the following description. The first rotation direction R1 is the direction in which the spacing cam 150 rotates in response to the main motor M1 rotating in the forward direction. As shown in FIGS. 8A and 8B, the inclined surface F3 causes the cam follower 170 to move from the non-pushing position to the pushing position when the spacing cam 150 rotates in a second direction of rotation R2, which will be referred to as “second rotation direction” in the following description. The second direction of rotation R2 is the direction in which the spacing cam 150 rotates in response to the main motor M1 rotating in the reverse direction. The second rotation direction R2 is opposite to the first rotation direction R1. In FIGS. 8A, 8B, 9A and 9B, the shape of the first base surface 151A of the spacing cam 150 is simplified for the sake of description.

As shown in FIG. 6, the spacing cam 150K corresponding to the color black includes a wall W.

The wall W includes a first wall W1 and a second wall W2. In the present embodiment, the spacing cams 150Y, 150M, 150C corresponding to the colors other than black include only the second wall W2 and do not include the first wall W1. However, the spacing cams 150Y, 150M, 150C may include the first wall W1. The structure of the second walls W2 of the spacing cams 150Y, 150M, 150C is the same as that of the second wall W2 of the spacing cam 150K; therefore, the description thereof will be omitted.

The first wall W1 and the second wall W2 are contactable with the cam follower 170K in the direction of rotation of the spacing cam 150K. The first wall W1 and the second wall W2 have a function of restricting rotation of the spacing cam 150K.

The first wall W1 protrudes from the first surface F1. The first wall W1 has an arcuate shape with a center on a rotation axis of the spacing cam 150K.

The second wall W2 protrudes from the second surface F2.

The first wall W1, the first surface F1, the inclined surface F3, the second surface F2 and the second wall W2 are aligned in this order in the direction of rotation of the spacing cam 150K. The spacing cam 150K is rotatable from a position in which the first wall W1 contacts the cam follower 170 to a position in which the second wall W2 contacts the cam follower 170.

Specifically, as shown in FIG. 8B, the first wall W1 has a first side surface W11 that contacts the cam follower 170. The second wall W2 has a second side surface W21 that contacts the cam follower 170. An angle θ1 formed by a first straight line Ll connecting the rotation axis X1 of the spacing cam 150K and the first side surface W11 and a second straight line L2 connecting the rotation axis X1 and the second side surface W21 is equal to or smaller than 180 degrees, as viewed in the rotation axis direction. In this embodiment, the angle θ1 formed by the first straight line Ll and the second straight line L2 is smaller than 180 degrees.

The spacing cam 150K rotates about the rotation axis X1. The spacing cam 150K rotates between a first phase in which the development roller 61K is located in the contact position and a second phase in which the development roller 61K is located in the spaced position. The spacing cam 150K rotates toward the first phase in response to the main motor M1 rotating in the forward direction and rotates toward the second phase in response to the main motor M1 rotating in the reverse direction.

Similarly, each of the spacing cams 150Y, 150M, 150C rotates between a first phase in which the corresponding development roller 61 is located in the contact position and a second phase in which the corresponding development roller 61 is located in the spaced position. Each of the spacing cams 150Y, 150M, 150C rotates toward the first phase in response to the main motor M1 rotating in the forward direction. Each of the spacing cams 150Y, 150M, 150C rotates toward the second phase in response to the main motor M1 rotating in the reverse direction.

Each of the cam followers 170 is located in the non-pushing position when the corresponding spacing cam 150 is located in the first phase. Each of the cam followers 170 is located in the pushing position when the corresponding spacing cam 150 is located in the second phase.

When the spacing cam 150K is located in the first phase, the first wall W1 may be in contact with the cam follower 170K or spaced apart from the cam follower 170K. When the spacing cam 150K is located in the second phase, the second wall W2 may be in contact with the cam follower 170K or spaced apart from the cam follower 170K. The second walls W2 of the spacing cams 150 corresponding to the colors other than black may also be in contact with the corresponding cam follower 170 or spaced apart from the corresponding cam follower 170 when the spacing cams 150 are located in the second phase.

The angle from the first phase to the second phase is equal to or smaller than 180 degrees. In this embodiment, the angle from the first phase to the second phase is smaller than 180 degrees.

The first phase may be the same phase for each color or may be a different phase for each color. Similarly, the second phase may be the same phase for each color or may be a different phase for each color. In this embodiment, the first phase corresponding to each color is the same. Further, the second phase is different for each color.

As shown in FIG. 6, the image forming apparatus 1 further comprises four shafts 159 and a metal plate 15 (see FIG. 5) as an example of a support member. The metal plate 15 is a member that supports the gears of the gear trains in a manner that allows the gears to rotate. As shown in FIGS. 12A and 12B, the shaft 159 is fixed to the metal plate 15. The boss 152 is engaged with the shaft 159 so that the spacing cam 150 (cam gear 115) is rotatably supported by the metal plate 15.

The metal plate 15 has a contact surface 15A that contacts the spacing cam 150. The second base surface 151B is opposed to the contact surface 15A. The boss 152 protrudes from the first base surface 151A and from the second base surface 151B.

As shown in FIG. 10A, the spacing cam 150K further includes a rib 156 and a reinforcement rib 157. The rib 156 and the reinforcement rib 157 protrude from the second base surface 151B.

The rib 156 has an arcuate shape with a center on the rotation axis of the spacing cam 150K. As shown in FIG. 10B, a central angle θ2 of the rib 156 is equal to or smaller than 180 degrees. In this embodiment, the central angle θ2 of the rib 156 is smaller than 180 degrees.

The rib 156 overlaps the cam portion 153 and the first wall W1 as viewed in the rotation axis direction. In more detail, the rib 156 overlaps the inclined surface F3 as viewed in the rotation axis direction.

The reinforcement rib 157 includes a first reinforcement rib 157A, a second reinforcement rib 157B and a third reinforcement rib 157C.

The first reinforcement rib 157A extends from one end of the rib 156 in the direction of rotation of the spacing cam 150K toward the rotation axis X1 of the spacing cam 150K.

The second reinforcement rib 157B extends from the other end of the rib 156 in the direction of rotation of the spacing cam 150K toward the rotation axis X1.

The third reinforcement rib 157C is located between the first reinforcement rib 157A and the second reinforcement rib 157B in the direction of rotation of the spacing cam 150K and extends from the rib 156 toward the rotation axis X1.

The first reinforcement rib 157A, the second reinforcement rib 157B and the third reinforcement rib 157C connect the rib 156 and the boss 152. The first reinforcement rib 157A, the second reinforcement rib 157B and the third reinforcement rib 157C each has a surface F11 inclined in such a manner that the closer to rotation axis X1, the closer to the second base surface 151B.

As shown in FIG. 12A, in a state where the spacing cam 150K is assembled onto the metal plate 15, each surface F11 is inclined in such a manner that the closer to the rotation axis X1, the farther from the contact surface 15A of the metal plate 15. The rib 156 is in contact with the metal plate 15 in the rotation axis direction.

As shown in FIG. 6, each cam follower 170 includes a slide shaft 171, an arm 172, a pin 173 and a projection 174 as an example of a first to-be-detected portion and a second to-be-detected portion.

The slide shaft 171 is slidable in the rotation axis direction. Specifically, the slide shaft 171 is shaped as a hollow cylinder. The slide shaft 171 is engaged with the boss 152 of the corresponding spacing cam 150 so that it is slidable in the rotation axis direction relative to the boss 152. This allows the cam follower 170 to slide in the rotation axis direction between the non-pushing position shown in FIGS. 8A and 8B and the pushing position shown in FIGS. 9A and 9B.

The arm 172 extends from the slide shaft 171 in a direction perpendicular to the rotation axis direction. In more detail, the arm 172 extends outward from the slide shaft 171 in a radial direction of the slide shaft 171. The arm 172 is plate-shaped. The arm 172 of the cam follower 170K corresponding to the color black is contactable with the first wall W1 in the direction of rotation of the spacing cam 150K. The arms 172 corresponding to each color are contactable with the corresponding second walls W2 in the direction of rotation of the corresponding spacing cams 150.

The pin 173 extends from the arm 172 in the rotation axis direction. Specifically, the pin 173 extends from an end of the arm 172 distant from the slide shaft 171 toward the one side in the rotation axis direction. The pin 173 is shaped as a hollow cylinder with an end having a convex surface. The end of the pin 173 pushes the development cartridge 60 when the cam follower moves from the non-pushing position to the pushing position. Specifically, the end of the pin 173 pushes the to-be-pushed surface 66D (see FIG. 7B) of the spacing shaft 66 provided on the development cartridge 60.

The projection 174 extends from the slide shaft 171 in a direction perpendicular to the rotation axis direction. Specifically, the projection 174 extends outward from the slide shaft 171 in a radial direction of the slide shaft 171. The projection 174 extends in a direction different from the direction in which the arm 172 extends. In the present embodiment, the projection 174 extends forward from the slide shaft 171, and the arm 172 extends obliquely rearward and downward from the slide shaft 171. The projection 174 moves in the rotation axis direction as the cam follower 170 moves in the rotation axis direction in response to rotation of the spacing cam 150.

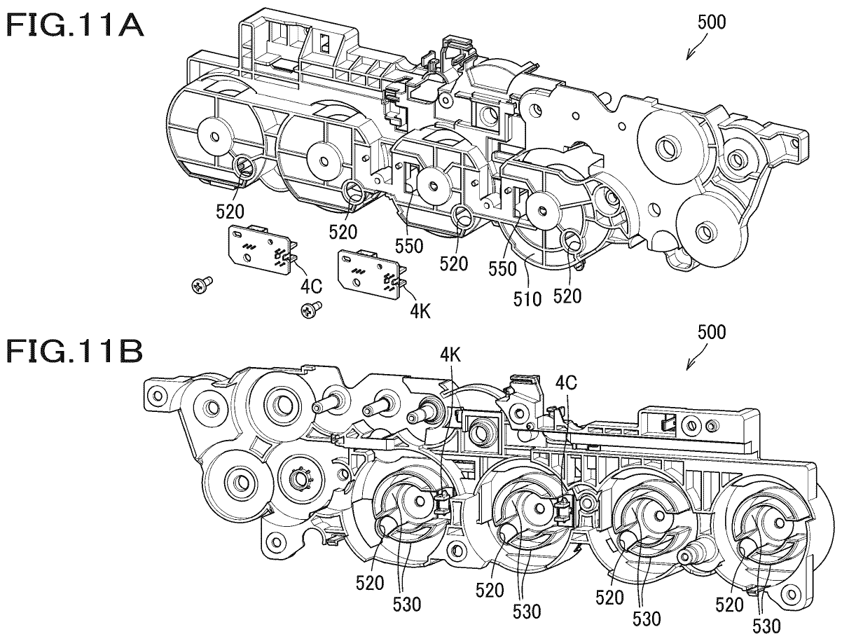

The image forming apparatus 1 further comprises stoppers 530. Four sets of stoppers 530 are provided, one set for each of the four cam followers 170. The stoppers 530 restrict the cam followers 170 from rotating in the direction of rotation of the spacing cams 150. In more detail, as shown in FIGS. 11A and 11B, the image forming apparatus 1 comprises a gear cover 500 as an example of a cover, and the gear cover 500 includes the stoppers 530.

The gear cover 500 is fixed to the metal plate 15 (see FIG. 5) and thereby covers the spacing cams 150 (cam gears 115) and the cam followers 170. The gear cover 500 includes a cover wall 510. The cover wall 510 is a wall that covers the spacing cams 150 and the cam followers 170, and is opposed to the metal plate 15 in the rotation axis direction in a state where the gear cover 500 is fixed to the metal plate 15.

The stoppers 530 extend from the cover wall 510 in the rotation axis direction toward the corresponding spacing cams 150. The stoppers 530 are shaped as walls. The stoppers 530 in each set of stoppers 530 are located on both sides of the arm 172 of the corresponding cam follower 170 in a circumferential direction of the slide shaft 171 (see FIGS. 8A, 8B, 9A and 9B). This restricts rotation of the cam follower 170 about the boss 152.

The cover wall 510 further has four insertion holes 520 and two through holes 550. The insertion holes 520 are through holes through which the pins 173 of the cam followers 170 are inserted (see FIGS. 12A and 12B). The through holes 550 are holes for attaching the sensors 4K, 4C shown in FIG. 11B to the gear cover 500.

As shown in FIG. 12A and 12B, the image forming apparatus 1 further comprises a spring 430. Four springs 430 are provided, one for each of the four cam followers 170. Each spring 430 biases the corresponding cam follower 170 from the pushing position shown in FIG. 12B toward the non-pushing position shown in FIG. 12A. As one example, the springs 430 are compression coil springs. Each spring 430 is located between the gear cover 500 and the slide shaft 171 of the corresponding cam follower 170. In more detail, each spring 430 is located between the cover wall 510 and the corresponding slide shaft 171.

Each slide shaft 171 includes a recess 171A. The recess 171A is an annular recess and opens toward the cover wall 510 in the rotation axis direction. At least one end of the spring 430 is located in the recess 171A. Misalignment of the spring 430 is limited by provision of the recess 171A.

As shown in FIGS. 9A and 9B, when the development cartridge 60 is located in the second position, i.e., when the development roller 61 is located in the spaced position, the cam follower 170 is located in the pushing position in which the arm 172 is retained by the second surface F2 of the spacing cam 150.

The spacing cam 150 rotates in the first rotation direction R1 in response to the main motor M1 rotating in the forward direction. When the spacing cam 150 rotates in the first rotation direction R1, the arm 172 of the cam follower 170 is guided from the second surface F2 to the inclined surface F3, slides on the inclined surface F3 and slides off the cam portion 153. That is, when the main motor M1 rotates in the forward direction, the cam follower 170 moves relative to the spacing cam 150 from the second surface F2 toward the first surface F1 by way of the inclined surface F3. As a result, the cam follower 170 slides from the pushing position to the non-pushing position shown in FIGS. 8A and 8B by the biasing force of the spring 430 (see FIGS. 12A and 12B).

In this way, the development cartridge 60 moves from the second position to the first position, and the development roller 61 moves from the spaced position to the contact position. Thus, the spacing cam 150 causes the development roller 61 to move from the spaced position to the contact position when the main motor M1 rotates in the forward direction.

On the other hand, the spacing cam 150 rotates in the second rotation direction R2 in response to the main motor M1 rotating in the reverse direction. When the spacing cam 150 rotates in the second rotation direction R2, the arm 172 of the cam follower 170 contacts the inclined surface F3 of the cam portion 153, slides on the inclined surface F3 and then contacts the second surface F2. That is, when the main motor M1 rotates in the reverse direction, the cam follower 170 moves relative to the spacing cam 150 from the first surface F1 toward the second surface F1 by way of the inclined surface F3. As a result, the cam follower 170 slides from the non-pushing position to the pushing position shown in FIGS. 9A and 9B.

In this way, the development cartridge 60 moves from the first position to the second position by being pushed by the cam follower 170, and the development roller 61 moves from the contact position to the spaced position. Thus, the spacing cam 150 causes the development roller 61 to move from the contact position to the spaced position when the main motor M1 rotates in the reverse direction.

As shown in FIG. 13, the development-spacing gear train GT1 comprises a color-side gear train GT11 as an example of a second gear train and a monochrome-side gear train GT12 as an example of a first gear train.

The color-side gear train GT11 transmits a driving force of the main motor M1 to the spacing cams 150Y, 150M, 150C. The color-side gear train GT11 connects the main motor M1 and the spacing cams 150Y, 150M, 150C.

The color-side gear train GT11 comprises a gear 101, a gear 102, a gear 103, a gear 104, a gear 105, a gear 106, a gear 107, a gear 108, a gear 109, an electromagnetic clutch EC1 as an example of a second electromagnetic clutch, a gear 110, a gear 111, a gear 112, a gear 113, a gear 114, a cam gear 115C, a gear 116, a cam gear 115M, a gear 118, and a cam gear 115Y.

The gear 101 is a two-stage gear including a large diameter gear and a small diameter gear. The large diameter gear of the gear 101 is engaged with a motor gear MG1. The motor gear MG1 is a gear provided on an output axis of the main motor M1. In other words, the image forming apparatus 1 comprises the motor gear MG1. The motor gear MG1 is engaged with the large diameter gear of the gear 101.

The gear 102 is engaged with the small diameter gear of the gear 101.

The gear 103 is a two-stage gear including a large diameter gear and a small diameter gear. The large diameter gear of the gear 103 is engaged with the gear 102.

The gear 104 is engaged with the small diameter gear of the gear 103.

The gear 105 is a two-stage gear including a large diameter gear and a small diameter gear. The large diameter gear of the gear 105 is engaged with the gear 104.

The gear 106 is engaged with the small diameter gear of the gear 105.

The gear 107 is engaged with the gear 106.

The gear 108 is engaged with the gear 107.

The gear 109 is engaged with the gear 108.

The electromagnetic clutch EC1 is switchable to a transmitting state and to an interrupting state. As one example, the electromagnetic clutch EC1 exhibits the transmitting state when energized and exhibits the interrupting state when not energized. The transmitting state is a state in which a driving force of the main motor M1 is transmitted to the spacing cams 150Y, 150M, 150C. The interrupting state is a state in which a driving force of the main motor M1 is not transmitted to the spacing cams 150Y, 150M, 150C. The electromagnetic clutch EC1 is controlled by the controller 2 (see FIG. 1).

The gear 110 rotates integrally with the gear 109 when the electromagnetic clutch EC1 is in the transmitting state. The gear 110 is not driven when the electromagnetic clutch

EC1 is in the interrupting state because a driving force of the main motor M1 is not transmitted thereto in the interrupting state.

The gear 111 is engaged with the gear 110.

The gear 112 is a two-stage gear including a large diameter gear and a small diameter gear. The large diameter gear of the gear 112 is engaged with the gear 111.

The gear 113 is a two-stage gear including a large diameter gear and a small diameter gear. The large diameter gear of the gear 113 is engaged with the small diameter gear of the gear 112.

The gear 114 is engaged with the small diameter gear of the gear 113.

The cam gear 115C is a gear including the spacing cam 150C. In other words, the spacing cam 150C has gear teeth formed on an outer periphery of its disc portion 151. The cam gear 115C is engaged with the gear 114.

The gear 116 is engaged with the cam gear 115C.

The cam gear 115M is a gear including the spacing cam 150M. In other words, the spacing cam 150M has gear teeth formed on an outer periphery of its disc portion 151. The cam gear 115M is engaged with the gear 116. The cam gear 115M receives a driving force of the main motor M1 from the cam gear 115C via the gear 116.

The gear 118 is engaged with the cam gear 115M.

The cam gear 115Y is a gear including the spacing cam 150Y. In other words, the spacing cam 150Y has gear teeth formed on an outer periphery of its disc portion 151. The cam gear 115Y is engaged with the gear 118.

The spacing cams 150Y, 150M, 150C rotate in conjunction with each other. The length of the second surface F2 of the spacing cams 150Y, 150M, 150C in the direction of rotation of the spacing cams 150 is longer in the order of the spacing cam 150Y, the spacing cam 150M and the spacing cam 150C. Phases of the downstream ends of the second surfaces F2 of the spacing cams 150Y, 150M, 150C are aligned in the first rotation direction R1, and phases of the inclined surfaces F3 of the spacing cams 150Y, 150M, 150C are misaligned in the first rotation direction R1. Specifically, the inclined surface F3 of the spacing cam 150Y is located downstream of the inclined surface F3 of the spacing cam 150M in the first rotation direction R1, and the inclined surface F3 of the spacing cam 150M is located downstream of the inclined surface F3 of the spacing cam 150C in the first rotation direction R1.

Accordingly, when the cam followers 170Y, 170M, 170C are located in the pushing position and the main motor M1 rotates in the forward direction to cause the spacing cams 150Y, 150M, 150C to rotate in the first rotation direction R1, the cam follower 170Y moves from the pushing position to the non-pushing position at the outset and thereby moves the development roller 61Y from the spaced position to the contact position. Next, the cam follower 170M moves from the pushing position to the non-pushing position and thereby moves the development roller 61M from the spaced position to the contact position. Lastly, the cam follower 170C moves from the pushing position to the non-pushing position and thereby moves the development roller 61C from the spaced position to the contact position.

On the other hand, when the cam followers 170Y, 170M, 170C are located in the non-pushing position and the main motor M1 rotates in the reverse direction to cause the spacing cams 150Y, 150M, 150C to rotate in the second rotation direction R2, the cam follower 170C moves from the non-pushing position to the pushing position at the outset and thereby moves the development roller 61C from the contact position to the spaced position. Next, the cam follower 170M moves from the non-pushing position to the pushing position and thereby moves the development roller 61M from the contact position to the spaced position. Lastly, the cam follower 170Y moves from the non-pushing position to the pushing position and thereby moves the development roller 61Y from the contact position to the spaced position.

The monochrome-side gear train GT12 transmits a driving force of the main motor M1 to the spacing cam 150K. The monochrome-side gear train GT12 connects the main motor M1 and the spacing cam 150K. The monochrome-side gear train GT12 comprises gears 101 to 106 shared with the color-side gear train GT11, a gear 121, an electromagnetic clutch EC2 as an example of a first electromagnetic clutch, a gear 122, a gear 123, an idle gear 124 and a cam gear 115K.

The gear 121 is engaged with the gear 106.

The electromagnetic clutch EC2 is switchable to a transmitting state and to an interrupting state. As one example, the electromagnetic clutch EC2 exhibits the transmitting state when energized and exhibits the interrupting state when not energized. The transmitting state is a state in which a driving force of the main motor M1 is transmitted to the spacing cam 150K. The interrupting state is a state in which a driving force of the main motor M1 is not transmitted to the spacing cam 150K. The electromagnetic clutch EC2 is controlled by the controller 2 (see FIG. 1).

The gear 122 rotates integrally with the gear 121 when the electromagnetic clutch EC2 is in the transmitting state. The gear 122 is not driven when the electromagnetic clutch EC2 is in the interrupting state because a driving force of the main motor M1 is not transmitted thereto.

The gear 123 is a two-stage gear including a large diameter gear and a small diameter gear. The large diameter gear of the gear 123 is engaged with the gear 122.

The idle gear 124 is engaged with the small diameter gear of the gear 123.

The cam gear 115K is a gear including the spacing cam 150K. In other words, the spacing cam 150K has gear teeth formed on an outer periphery of its disc portion 151. The cam gear 115K is engaged with the idle gear 124.

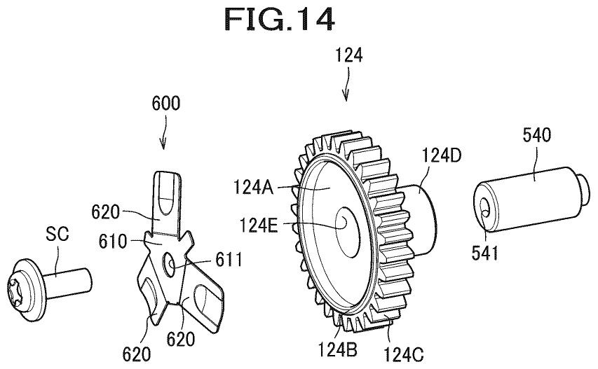

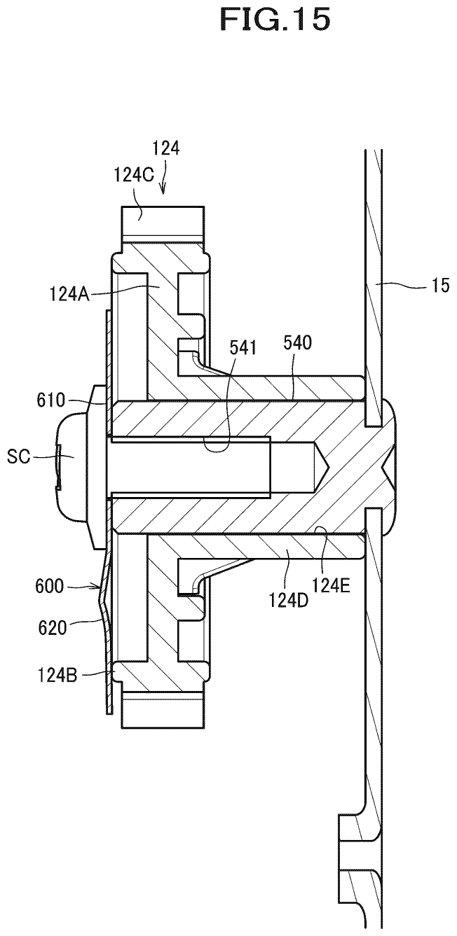

As shown in FIGS. 14 and 15, the idle gear 124 includes a disc portion 124A, a rib 124B, a gear portion 124C and a protrusion 124D.

The rib 124B is shaped as a hollow cylinder. The rib 124B protrudes from an outer periphery of the disc portion 124A toward the one side and the other side in the rotation axis direction.

The gear portion 124C is formed on an outer periphery of the rib 124B.

The rib 124B protrudes further away, than the gear portion 124C, from the metal plate 15.

The protrusion 124D protrudes from a central portion of the disc portion 124A toward the metal plate 15. The protrusion 124D is in contact with the metal plate 15.

The idle gear 124 has a hole 124E that extends through the disc portion 124A and the protrusion 124D.

The image forming apparatus 1 further comprises a shaft 540, a leaf spring 600 and a screw SC.

The shaft 540 is fixed to the metal plate 15. The shaft 540 is located in the hole 124E of the idle gear 124. The shaft 540 supports the idle gear 124 in a manner that allows the idle gear 124 to rotate.

The leaf spring 600 biases the idle gear 124 in the rotation axis direction so that the idle gear 124 contacts the metal plate 15. The leaf spring 600 imparts a rotational resistance to the idle gear 124. The leaf spring 600 is made of sheet metal. The leaf spring 600 includes a base 610 and three pressing portions 620.

The base 610 is fixed to the shaft 540 by the screw SC. The base 610 has a through hole 611 in a central portion thereof. The through hole 611 is a hole through which a shaft portion of the screw SC passes. The shaft 540 has a hole 541 into which the screw SC is screwed.

The pressing portions 620 are portions which press the idle gear 124 against the metal plate 15. The pressing portions 620 extend obliquely outward from the base 610. The three pressing portions 620 are out of phase with each other by 120 degrees in a direction of rotation of the idle gear 124. The pressing portions 620 are in contact with the rib 124B of the idle gear 124.

Rotation of the leaf spring 600 about the rotation axis of the idle gear 124 is restricted by a stopper provided on a cover that covers the leaf spring 600.

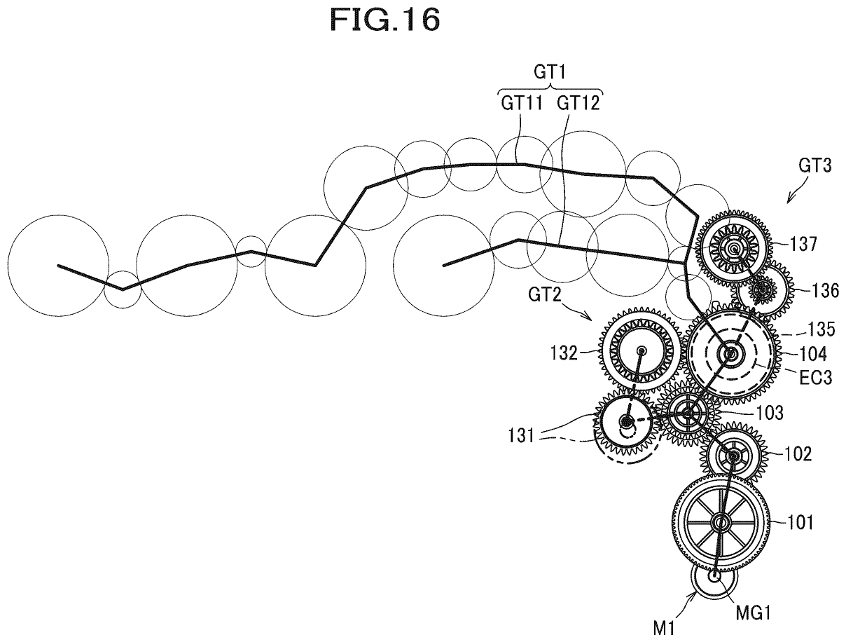

As shown in FIG. 16, the fixing-driving gear train GT2 comprises a moving gear 131 and an output gear 132.

The moving gear 131 receives a driving force from the main motor M1. The moving gear 131 is engaged with the large diameter gear of the gear 103 provided in the color-side gear train GT11. The moving gear 131 is movable relative to the output gear 132 between a transmitting position shown by a solid line and an interrupting position shown by a dashed-double dotted line. In more detail, the moving gear 131 is swingable about the gear 103 between the transmitting position and the interrupting position.

The transmitting position is a position in which the moving gear 131 is engaged with the output gear 132, and the interrupting position is a position in which the moving gear 131 is not engaged with the output gear 132. The moving gear 131 is located in the transmitting position when the main motor M1 rotates in the forward direction and is located in the interrupting position when the main motor M1 rotates in the reverse direction.

The output gear 132 outputs a driving force to the fixing device 80. In more detail, the output gear 132 outputs the driving force to the heating roller 81A. The output gear 132 is a two-stage gear including a large diameter gear and a small diameter gear. The large diameter gear of the output gear 132 engages the moving gear 131 located in the transmitting position.

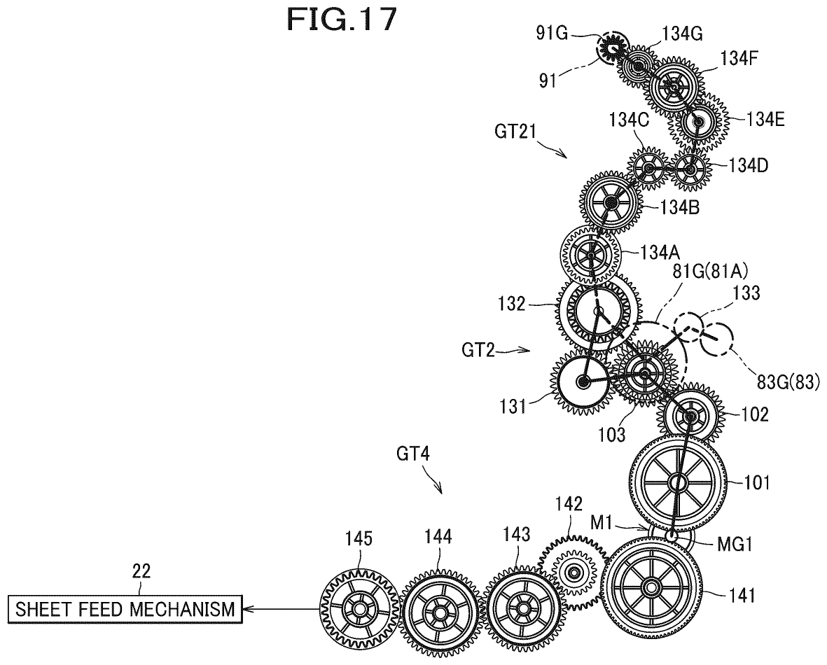

As shown in FIG. 17, the heating roller 81A comprises a heating roller gear 81G fixed on one end thereof. The small diameter gear of the output gear 132 is engaged with the heating roller gear 81G. The pressure member 82 (pressure roller) of the fixing device 80 rotates in accordance with the heating roller 81A as the heating roller 81A rotates.

The first ejection roller 83 and the second ejection roller 91 receive a driving force of the main motor M1 from the fixing-driving gear train GT2. The first ejection roller 83 comprises a first ejection roller gear 83G fixed to an end of one of the rollers. The second ejection roller 91 comprises a second ejection roller gear 91G fixed to an end of one of the rollers.

The image forming apparatus 1 further comprises a gear 133 and an ejection-driving gear train GT21.

The gear 133 is engaged with the heating roller gear 81G, and the first ejection roller 83 is engaged with the gear 133. Accordingly, the first ejection roller 83 rotates when it receives a driving force of the main motor M1 from the output gear 132 of the fixing-driving gear train GT2 via the heating roller gear 81G and the gear 133.

The ejection-driving gear train GT21 comprises a gear 134A, a gear 134B, a gear 134C, a gear 134D, a gear 134E, a gear 134F and a gear 134G.

The gear 134A is engaged with the small diameter gear of the output gear 132.

The gear 134B is engaged with the gear 134A.

The gear 134C is engaged with the gear 134B.

The gear 134D is engaged with the gear 134C.

The gear 134E is a two-stage gear including a large diameter gear and a small diameter gear. The large diameter gear of the gear 134E is engaged with the gear 134D.

The gear 134F is a two-stage gear including a large diameter gear and a small diameter gear. The large diameter gear of the gear 134F is engaged with the small diameter gear of the gear 134E.

The gear 134G is engaged with the small diameter gear of the gear 134F.

The second ejection roller gear 91G is engaged with the gear 134G. Accordingly, the second ejection roller 91 rotates when it receives a driving force of the main motor M1 from the output gear 132 of the fixing-driving gear train GT2 via the ejection-driving gear train GT21.

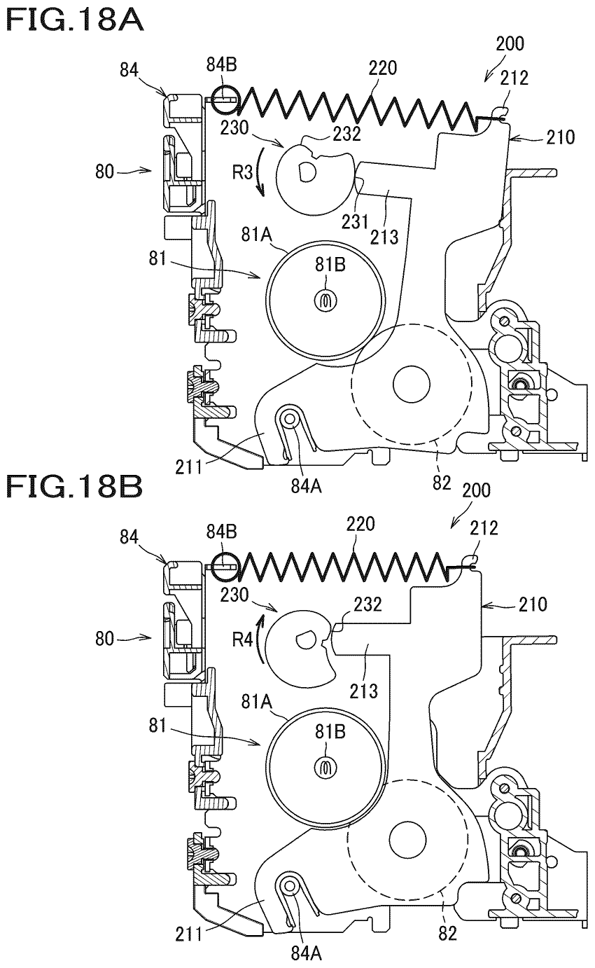

As shown in FIGS. 18A and 18B, the nip pressure adjusting mechanism 200 is a mechanism for changing a nip pressure of the heating member 81 and the pressure member 82 in response to receiving a driving force from the main motor M1. In more detail, the nip pressure adjusting mechanism 200 changes the nip pressure of the heating roller 81A and the pressure member 82 to a first nip pressure shown in FIG. 18A and to a second nip pressure shown in FIG. 18B.

The second nip pressure is greater than the first nip pressure. In the present embodiment, the first nip pressure is a nip pressure applied during a standby state before printing is performed, and the second nip pressure is a nip pressure applied while printing is performed. In the present embodiment, the heating member 81 and the pressure member 82 are in contact with each other even when the first nip pressure is applied. In the following description, the first nip pressure is also referred to as “low nip pressure” and the second nip pressure is also referred to as “high nip pressure”.

The nip pressure adjusting mechanism 200 is provided at the fixing device 80. The fixing device 80 further comprises a fixing frame 84 and the nip pressure adjusting mechanism 200.

The fixing frame 84 supports the heating member 81. Specifically, the fixing frame 84 supports the heating roller 81A in a manner that allows the heating roller 81A to rotate. The fixing frame 84 comprises a shaft portion 84A and a spring engagement portion 84B on both sides thereof in the rotation axis direction.

The nip pressure adjusting mechanism 200 comprises an arm 210, a spring 220 and a nip pressure adjusting cam 230. The arm 210, the spring 220 and the nip pressure adjusting cam 230 are provided on both sides of the pressure member 82 in the rotation axis direction.

The arm 210 supports the pressure member 82 (pressure roller) in a manner that allows the pressure member 82 to rotate. The arm 210 has a first end 211, a second end 212 and a cam contact portion 213. The first end 211 of the arm 210 is engaged with the shaft portion 84A of the fixing frame 84; thus, the arm 210 is rotatably supported on the fixing frame 84. The cam contact portion 213 extends toward the nip pressure adjusting cam 230 at a position between the first end 211 and the second end 212.

The spring 220 biases the pressure member 82 toward the heating member 81. As one example, the spring 220 is a helical extension spring. One end of the spring 220 is engaged with the spring engagement portion 84B of the fixing frame 84 and the other end of the spring 220 is engaged with the second end 212 of the arm 210.

The nip pressure adjusting cam 230 changes the nip pressure of the heating member 81 and the pressure member 82 to a first nip pressure and to a second nip pressure in response to receiving a driving force from the main motor M1. The nip pressure adjusting cam 230 changes the nip pressure of the heating roller 81A and the pressure member 82 (pressure roller) to a first nip pressure shown in FIG. 18A and a second nip pressure shown in FIG. 18B in response to receiving a driving force from the main motor M1.

The nip pressure adjusting cam 230 is rotatably supported on the fixing frame 84. In more detail, the nip pressure adjusting cam 230 is rotatable about an axis parallel to the rotation axis of the heating roller 81A. The nip pressure adjusting cam 230 is rotatable between a first cam phase shown in FIG. 18A and a second cam phase shown in FIG. 18B. The nip pressure adjusting cam 230 is a plate cam. Specifically, the nip pressure adjusting cam 230 includes a first region 231 and a second region 232 on an outer peripheral surface thereof.

The first region 231 is a region that contacts the cam contact portion 213 of the arm 210 when the nip pressure adjusting cam 230 is in the first cam phase shown in FIG. 18A. The nip pressure of the heating member 81 and the pressure member 82 is the low nip pressure when the nip pressure adjusting cam 230 is in the first cam phase.

The second region 232 is a region that is opposed to the cam contact portion 213 when the nip pressure adjusting cam 230 is in the second cam phase shown in FIG. 18B. When the nip pressure adjusting cam 230 is in the second cam phase, the second region 232 is spaced apart from the cam contact portion 213. The nip pressure of the heating member 81 and the pressure member 82 is the high nip pressure when the nip pressure adjusting cam 230 is in the second cam phase.

The nip pressure adjusting mechanism 200 changes the nip pressure of the heating member 81 and the pressure member 82 from the low nip pressure to the high nip pressure by the nip pressure adjusting cam 230 rotating 270 degrees in a third direction of rotation R3 (shown in FIG. 18A) from the first cam phase to the second cam phase (shown in FIG. 18B). The third direction of rotation R3 will be referred to as “third rotation direction” in the following description. The third rotation direction R3 is the direction in which the nip pressure adjusting cam 230 rotates in response to the main motor M1 rotating in the forward direction.

The nip pressure adjusting mechanism 200 changes the nip pressure of the heating member 81 and the pressure member 82 from the high nip pressure to the low nip pressure by the nip pressure adjusting cam 230 rotating in a fourth direction of rotation R4 (shown in FIG. 18B) from the second cam phase to the first cam phase (shown in FIG. 18A). The fourth direction of rotation R4 will be referred to as “fourth rotation direction” in the following description. The fourth rotation direction R4 is the direction in which the nip pressure adjusting cam 230 rotates in response to the main motor M1 rotating in the reverse direction. The fourth rotation direction R4 is a direction of rotation opposite to the third rotation direction R3.

As shown in FIG. 16, the nip-pressure-adjusting gear train GT3 comprises a clutch connection gear 135, a gear 136 and a gear 137. The image forming apparatus 1 further comprises an electromagnetic clutch EC3.

The electromagnetic clutch EC3 is switchable to a transmitting state and to an interrupting state. As one example, the electromagnetic clutch EC3 exhibits the transmitting state when energized and exhibits the interrupting state when not energized. The transmitting state is a state in which a driving force of the main motor M1 is transmitted from the development-spacing gear train GT1 to the nip-pressure-adjusting gear train GT3. That is, the transmitting state is a state in which a driving force of the main motor M1 is transmitted to the nip pressure adjusting cam 230. The interrupting state is a state in which a driving force of the main motor M1 is not transmitted from the development-spacing gear train GT1 to the nip-pressure-adjusting gear train GT3. That is, the interrupting state is a state in which a driving force of the main motor M1 is not transmitted to the nip pressure adjusting cam 230. The electromagnetic clutch EC3 is controlled by the controller 2 (see FIG. 1).

The clutch connection gear 135 rotates integrally with the gear 104 of the development-spacing gear train GT1 when the electromagnetic clutch EC3 is in the transmitting state. The clutch connection gear 135 rotates coaxially with the gear 104. The clutch connection gear 135 is not driven when the electromagnetic clutch EC3 is in the interrupting state because a driving force of the main motor M1 is not transmitted thereto.

The gear 136 is a two-stage gear including a large diameter gear and a small diameter gear. The large diameter gear of the gear 136 is engaged with the clutch connection gear 135.

The gear 137 is a two-stage gear including a large diameter gear and a small diameter gear. The large diameter gear of the gear 137 is engaged with the small diameter gear of the gear 136. The nip pressure adjusting cam 230 of the nip pressure adjusting mechanism 200 (see FIGS. 18A and 18B) rotates upon receiving a driving force of the main motor M1 from the small diameter gear of the gear 137.

As shown in FIG. 17, the sheet-feeding gear train GT4 comprises a gear 141, a gear 142, a gear 143, a gear 144 and a gear 145.

The gear 141 is a two-stage gear including a large diameter gear and a small diameter gear. The large diameter gear of the gear 141 is engaged with the motor gear MG1.

The gear 142 is a two-stage gear including a large diameter gear and a small diameter gear. The large diameter gear of the gear 142 is engaged with the small diameter gear of the gear 141.

The gear 143 is engaged with the small diameter gear of the gear 142.

The gear 144 is engaged with the gear 143.

The gear 145 is engaged with the gear 144. The gear 145 outputs a driving force to the sheet feed mechanism 22. The sheet feed mechanism 22 receives a driving force from the main motor M1 and thereby feeds a sheet S toward the image forming unit 30.

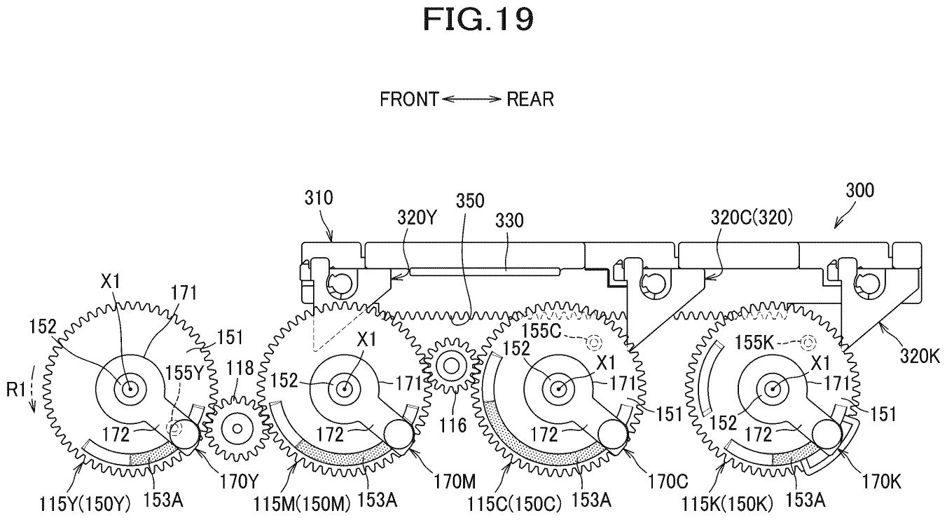

As shown in FIG. 19, the image forming apparatus 1 further comprises a slider 300 that is movable in the front-rear direction. The slider 300 has a function of locating the cam followers 170 in the non-pushing position by causing the spacing cams 150 to rotate in response to the front cover 11 being opened. The slider 300 is located above the rotation axes X1 of the spacing cams 150 (150Y, 150M, 150C, 150K). In this embodiment, the slider 300 is located above the bosses 152 of the spacing cams 150.

The slider 300 comprises a slide plate 310 and three contact pieces 320. The spacing cam 150C includes a first projection 155C as a projection, the spacing cam 150Y includes a second projection 155Y, and the spacing cam 150K includes a third projection 155K.

The first projection 155C is contactable with the slider 300 and causes the spacing cams 150C, 150M, 150Y to rotate upon contact with the slider 300 moving forward. The first projection 155C protrudes from the disc portion 151 of the spacing cam 150C in the rotation axis direction. In more detail, the first projection 155C protrudes from the disc portion 151 toward the other side in the rotation axis direction.

The second projection 155Y is contactable with the slider 300 and causes the spacing cams 150Y, 150M, 150C to rotate upon contact with the slider 300 moving forward. The second projection 155Y protrudes from the disc portion 151 of the spacing cam 150Y in the rotation axis direction. In more detail, the second projection 155Y protrudes from the disc portion 151 toward the other side in the rotation axis direction.

The third projection 155K is contactable with the slider 300 and causes the spacing cam 150K to rotate upon contact with the slider 300 moving forward. The third projection 155K protrudes from the disc portion 151 of the spacing cam 150K in the rotation axis direction. In more detail, the third projection 155K protrudes from the disc portion 151 toward the other side in the rotation axis direction.

The slider plate 310 is supported relative to the housing 10 in a manner that allows the slider plate 310 to translate forward and rearward.

The contact pieces 320 are supported by the slide plate 310 and move forward and rearward together with the slide plate 310. The contact pieces 320 include a first contact piece 320C, a second contact piece 320Y and a third contact piece 320K.

The first contact piece 320C contacts the first projection 155C of the spacing cam 150C when the slider 300 moves forward in a state where the cam followers 170Y, 170M, 170C are located in the pushing position. When the first contact piece 320C contacts the first projection 155C while the slider 300 is moving forward, the first contact piece 320C causes the spacing cams 150Y, 150M, 150C to rotate in the first rotation direction R1.

The second contact piece 320Y contacts the second projection 155Y of the spacing cam 150Y when the slider 300 moves forward after the first contact piece 320C is separated from the first projection 155C of the spacing cam 150C. When the second contact piece 320Y contacts the second projection 155Y while the slider 300 is moving forward, the second contact piece 320Y causes the spacing cams 150Y, 150M, 150C to rotate further in the first rotation direction R1 to locate the cam followers 170Y, 170M, 170K in the non-pushing position.

The third contact piece 320K contacts the third projection 155K of the spacing cam 150K when the slider 300 moves forward in a state where the cam follower 170K is located in the pushing position. When the third contact piece 320K contacts the third projection 155K while the slider 300 is moving forward, the third contact piece 320K causes the spacing cam 150K to rotate in the first rotation direction R1 to locate the cam follower 170K in the non-pushing position.

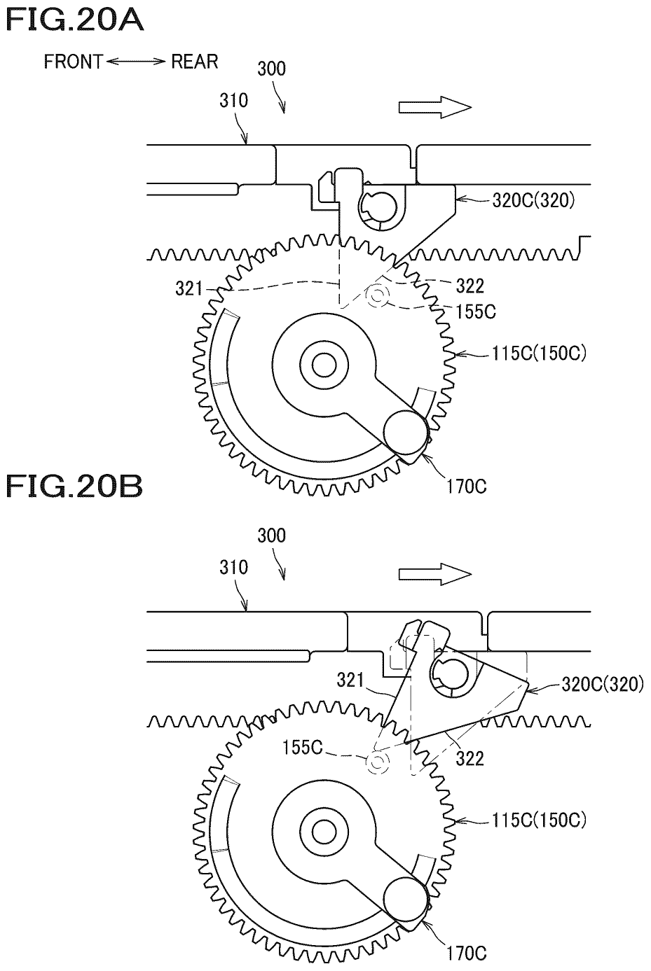

As shown in FIGS. 20A and 20B, the contact pieces 320 (320C, 320Y, 320K) are swingably supported by the slide plate 310. The contact pieces 320 are swingable between an acting position shown in FIG. 20A and a retracted position shown by solid lines in FIG. 20B. The contact pieces 320 are biased from the retracted position toward the acting position by a spring.

As shown in FIG. 20A, each contact piece 320 has a first contact surface 321 and a second contact surface 322.

The first contact surface 321 is approximately perpendicular to a direction of movement of the slider 300 in a state where the contact piece 320 is located in the acting position. The first contact surface 321 of the first contact piece 320C contacts the first projection 155C of the spacing cam 150C when the slider 300 moves forward in a state where the cam followers 170Y, 170M, 170C are located in the pushing position.

The first contact surface 321 of the second contact piece 320Y is contactable with the second projection 155Y of the spacing cam 150Y when the slider 300 moves forward. The first contact surface 321 of the third contact piece 320K contacts the third projection 155K of the spacing cam 150K when the slider 300 moves forward in a state where the cam follower 170K is located in the pushing position.

The second contact surface 322 is inclined with respect to the direction of movement of the slider 300 in a state where the contact piece 320 is located in the acting position. The second contact surface 322 is contactable with the first projection 155C, the second projection 155Y and the third projection 155K when the slider 300 moves rearward, i.e., when the front cover 11 is being closed.

The contact piece 320 is retracted from the acting position to the retracted position shown by solid lines in FIG. 20B when, for example, the second contact surface 322 contacts the first projection 155C of the spacing cam 150C while the slider 300 is moving rearward. Accordingly, the slider 300 does not cause the spacing cams 150C, 150M, 150Y to rotate while the slider 300 is moving rearward.

The same is true when the second contact surface 322 contacts the second projection 155Y of the spacing cam 150Y while the slider 300 is moving rearward, i.e., the slider 300 does not cause the spacing cams 150Y, 150M, 150C to rotate. Further, the same is true when the second contact surface 322 contacts the third projection 155K of the spacing cam 150K while the slider 300 is moving rearward, i.e., the slider 300 does not cause the spacing cam 150K to rotate.

As shown in FIG. 4, the image forming apparatus 1 further comprises a sensor 4K as an example of a first sensor, and a sensor 4C as an example of a second sensor. The sensors 4K, 4C are sensors for directly detecting the cam followers 170.

The sensor 4K detects the position of the cam follower 170K in the rotation axis direction. The sensor 4C detects the positions of the cam followers 170Y, 170M, 170C in the rotation axis direction. The sensor 4C directly detects the position of the cam follower 170C and indirectly detects the positions of the cam followers 170Y, 170M.

The sensors 4K, 4C are photo interrupters. Each of the sensors 4K, 4C includes a light emitting element 4P and a light receiving element 4R. The light emitting element 4P emits a detection light. The light receiving element 4R is capable of receiving the detection light from the light emitting element 4P. The light emitting elements 4P and the light receiving elements 4R of the sensors 4K, 4C are positioned inside the gear cover 500 through the through holes 550 (see FIGS. 11A and 11B).

The gear cover 500 supports the sensors 4K, 4C. As shown in FIGS. 4, 8A and 8B, the light emitting elements 4P and the light receiving elements 4R are located closer, than the corresponding cam portion 153, to the rotation axis X1 of the corresponding spacing cam 150.

As shown in FIGS. 8A, 9A, 12A and 12B, the projection 174 of the cam follower 170K is located between the light emitting element 4P and the light receiving element 4R when the cam follower 170K is located in the pushing position, and is displaced from between the light emitting element 4P and the light receiving element 4R when the cam follower 170K is located in the non-pushing position. Similarly, the projection 174 of the cam follower 170C is located between the light emitting element 4P and the light receiving element 4R when the cam follower 170C is located in the pushing position, and is displaced from between the light emitting element 4P and the light receiving element 4R when the cam follower 170C is located in the non-pushing position.

In this way, in each of the sensors 4K, 4C, the light receiving element 4R cannot receive the detection light from the light emitting element 4P when the cam follower 170 is located in the pushing position because the detection light is blocked by the projection 174. Further, in each of the sensors 4K, 4C, the light receiving element 4R can receive the detection light from the light emitting element 4P when the cam follower 170 is located in the non-pushing position. Each of the sensors 4K, 4C detects whether the cam follower 170 is located in the pushing position or the non-pushing position by the change in the state of reception of the detection light.

When the cam followers 170 are located in the pushing position, the corresponding development rollers 61 are located in the spaced position. When the cam followers 170 are located in the non-pushing position, the corresponding development rollers 61 are located in the contact position. Accordingly, the sensors 4K, 4C can detect whether the development rollers 61 are located in the spaced position or the contact position via the cam followers 170.

The projection 174 of the cam follower 170K is detectable by the sensor 4K, and the projection 174 of the cam follower 170C is detectable by the sensor 4C.

The sensor 4K detects the projection 174 of the cam follower 170K when the spacing cam 150K is located in the second phase.

The sensor 4C detects the projection 174 of the cam follower 170C when the spacing cam 150C is located in the second phase.

In this embodiment, the four cam followers 170 are common parts including a projection 174. However, the projections 174 of the cam followers 170Y, 170M do not function as portions to be detected by the sensors 4K, 4C.

The controller 2 (see FIG. 1) includes a central processing unit (CPU), a read-only memory (ROM), a random-access memory (RAM) and an input/output circuit, and exercises control by executing programs stored in advance. The controller 2 controls the startup and shutdown of the main motor M1, and the direction of rotation of the output axis of the main motor M1. The controller 2 also controls the startup and shutdown of the process motor M2. Further, the controller 2 controls the electromagnetic clutches EC1 to EC3.

In this way, the controller 2 controls the contact and separation of the development rollers 61 with respect to the photosensitive drums 50. The controller 2 also controls the driving and stopping of the photosensitive drums 50, the development rollers 61 and the heating roller 81A. Further, the controller 2 controls the nip pressure of the heating member 81 and the pressure member 82 of the fixing device 80.

The controller 2 is capable of executing a color printing mode as a first printing mode, and a monochrome printing mode as a second printing mode.

The color printing mode is a printing mode in which an image is formed on a sheet S with the development roller 61Y, development roller 61M, the development roller 61C and the development roller 61K.

In the standby state before printing is performed, all of the development rollers 61 are located in the spaced position. The color printing mode is a printing mode in which all of the development rollers 61 (61Y, 61M, 61C, 61K) are moved from the spaced position to the contact position to form the image on the sheet S.

The monochrome printing mode is a printing mode in which an image is formed on a sheet S with only the development roller 61K. Specifically, the monochrome printing mode is a printing mode in which only the development roller 61K is moved from the spaced position to the contact position to form the image on the sheet S.

The controller 2 is capable of executing a first forward rotation process, a first reverse rotation process, a second forward rotation process, a second reverse rotation process and an initial position return process.

The first forward rotation process is a process of rotating the spacing cam 150K toward the first phase by rotating the main motor M1 in the forward direction and then stopping the spacing cam 150K. In the first forward rotation process, the controller 2 stops the spacing cam 150K on the condition that the projection 174 is undetectable by the sensor 4K.

Here, “the projection 174 is undetectable by the sensor 4K” refers to a state in which the sensor 4K does not detect the projection 174. In the following description, a state of the sensor 4K when the sensor 4K is not detecting the projection 174, i.e., when the light receiving element 4R is receiving the detection light is also referred to as “off”. A state of the sensor 4K when the sensor 4K is detecting the projection 174, i.e., when the detection light is blocked by the projection 174 and is not received by the light receiving element 4R is also referred to as “on”. It should be understood that the same is true for the sensor 4C.

In the first forward rotation process, the controller 2 stops the spacing cam 150K after a first predetermined time period has elapsed from when the sensor 4K has been switched from “on” to “off”. In the present embodiment, the first predetermined time period is the traveling time of the spacing cam 150K from when the sensor 4K is switched from “on” to “off” until the spacing cam 150K reaches the first phase. The first predetermined time period may be shorter than the traveling time, for example, the first predetermined time period may be zero.

The first reverse rotation process is a process of rotating the spacing cam 150K toward the second phase by rotating the main motor M1 in the reverse direction and then stopping the spacing cam 150K at the second phase. In the first reverse rotation process, the controller 2 stops the spacing cam 150K at the second phase on the condition that the sensor 4K detects the projection 174. Specifically, in the first reverse rotation process, the controller 2 stops the spacing cam 150K after a second predetermined time period has elapsed from when the sensor 4K has been switched from “off” to “on” to stop the spacing cam 150K at the second phase. The second predetermined time period may be zero.

The second forward rotation process is a process of rotating the spacing cams 150Y, 150M, 150C toward the first phase by rotating the main motor M1 in the forward direction and then stopping the spacing cams 150Y, 150M, 150C. In the second forward rotation process, the controller 2 stops the spacing cams 150Y, 150M, 150C on the condition that the projection 174 is undetectable by the sensor 4C.

In the second forward rotation process, the controller 2 stops the spacing cams 150Y, 150M, 150C after a third predetermined time period has elapsed from when the sensor 4C has been switched from “on” to “off”. In the present embodiment, the third predetermined time period is the traveling time of the spacing cams 150Y, 150M, 150C from when the sensor 4C is switched from “on” to “off” until the spacing cams 150Y, 150M, 150C reach the first phase. The third predetermined time period may be shorter than the traveling time, for example, the third predetermined time period may be zero.

The second reverse rotation process is a process of rotating the spacing cams 150Y, 150M, 150C toward the second phase by rotating the main motor M1 in the reverse direction and then stopping the spacing cams 150Y, 150M, 150C at the second phase. In the second reverse rotation process, the controller 2 stops the spacing cams 150Y, 150M, 150C at the second phase on the condition that the sensor 4C detects the projection 174. Specifically, in the second reverse rotation process, the controller 2 stops the spacing cams 150Y, 150M, 150C after a fourth predetermined time period has elapsed from when the sensor 4C has been switched from “off” to “on” to stop the spacing cams 150Y, 150M, 150C at the second phase. The fourth predetermined time period may be zero.

The controller 2 executes the first forward rotation process by rotating the main motor M1 in the forward direction and controlling the electromagnetic clutch EC2. The controller 2 executes the first reverse rotation process by rotating the main motor M1 in the reverse direction and controlling the electromagnetic clutch EC2. In the first forward rotation process or the first reverse rotation process, the controller 2 causes the spacing cam 150K to rotate or to stop by controlling the electromagnetic clutch EC2.

The controller 2 executes the second forward rotation process by rotating the main motor M1 in the forward direction and controlling the electromagnetic clutch EC1. The controller 2 executes the second reverse rotation process by rotating the main motor M1 in the reverse direction and controlling the electromagnetic clutch EC1. In the second forward rotation process or the second reverse rotation process, the controller 2 controls the electromagnetic clutch EC1 to rotate and stop the spacing cams 150Y, 150M, 150C.

The initial position return process is a process in which the spacing cam 150K is returned to the second phase as the initial position based on a signal from the sensor 4K. The controller 2 executes the initial position return process, for example, when the front cover 11 has been closed or when printing is restarted after an error has occurred during printing.

The controller 2 executes the first reverse rotation process when the projection 174 is undetectable by the sensor 4K, i.e., when the sensor 4K is “off”, upon start of the initial position return process. The controller 2 executes the first forward rotation process and then executes the first reverse rotation process when the sensor 4K detects the projection 174, i.e., when the sensor 4K is “on”, upon start of the initial position return process.

In the initial position return process, the controller 2 is capable of returning the spacing cams 150Y, 150M, 150C to the second phase as the initial position based on a signal from the sensor 4C.

The controller 2 executes the second reverse rotation process when the projection 174 is undetectable by the sensor 4C, i.e., when the sensor 4C is “off”, upon start of the initial position return process. The controller 2 executes the second forward rotation process and then executes the second reverse rotation process when the sensor 4C detects the projection 174, i.e., when the sensor 4C is “on”, upon start of the initial position return process.

That is, if the sensor 4K is “on” and the sensor 4C is “on” upon start of the initial position return process, the controller 2 executes the first forward rotation process and the second forward rotation process and then executes the first reverse rotation process and the second reverse rotation process. If the sensor 4K is “off” and the sensor 4C is “on” upon start of the initial position return process, the controller 2 executes the second forward rotation process and then executes the first reverse rotation process and the second reverse rotation process. If the sensor 4K is “off” and the sensor 4C is “off” upon start of the initial position return process, the controller 2 executes the first reverse rotation process and the second reverse rotation process.

When the first forward rotation process and the second forward rotation process are executed in the initial position return process, the controller 2 executes the first forward rotation process and the second forward rotation process such that the execution period of the first forward rotation process and the execution period of the second forward rotation process overlap each other. For example, when the first forward rotation process and the second forward rotation process are executed in the initial position return process, the controller 2 starts the first forward rotation process and the second forward rotation process at the same time.

In the initial position return process, the controller 2 executes the first reverse rotation process and the second reverse rotation process such that the execution period of the first reverse rotation process and the execution period of the second reverse rotation process do not overlap each other. In the present embodiment, the controller 2 executes the second reverse rotation process after the first reverse rotation process.

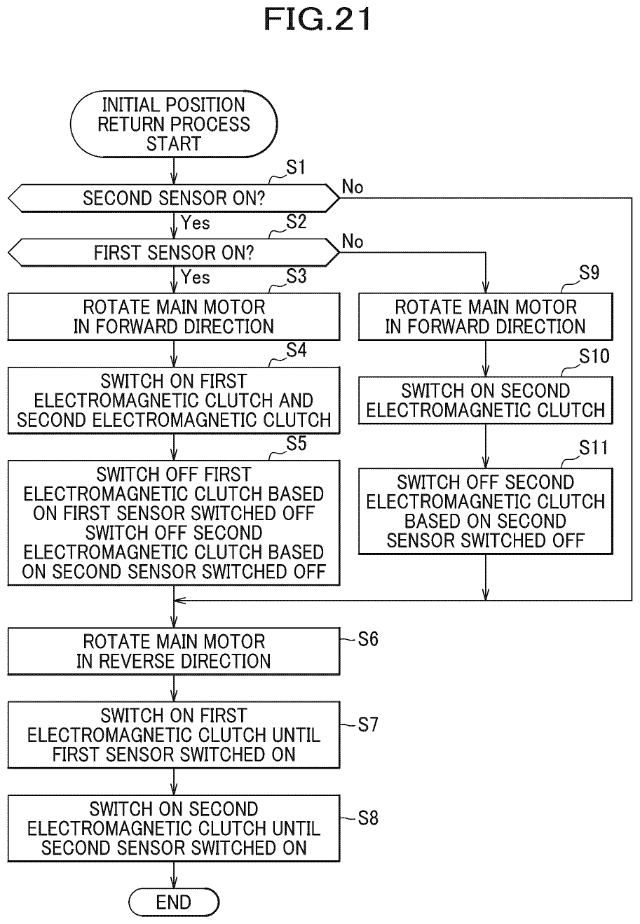

Next, the initial position return process will be described in detail. The controller 2 executes the initial position return process shown in FIG. 21, for example, when the front cover 11 has been closed. In FIG. 21, the sensor 4K is indicated as “first sensor”, the sensor 4C is indicated as “second sensor”, the electromagnetic clutch EC2 is indicated as “first electromagnetic clutch” and the electromagnetic clutch EC1 is indicated as “second electromagnetic clutch” for the sake of description. These parts will also be referred to in the following description by the designations given above.

In FIG. 21, the steps S3 to S5 correspond to the first forward rotation process and the second forward rotation process. Steps S6 to S8 correspond to the first reverse rotation process and the second reverse rotation process. Steps S9 to S11 correspond to the second forward rotation process.

In the initial position return process, the controller 2 first determines whether or not the second sensor is “on” (S1). If it is determined that the second sensor is “on” in step S1 (Yes), the controller 2 determines whether or not the first sensor is “on” (S2). If it is determined that the first sensor is “on” in step S2 (Yes), the controller 2 causes the main motor M1 to rotate in the forward direction (S3).

After step S3, the controller 2 switches “on” the first electromagnetic clutch and the second electromagnetic clutch at the same time (S4). After step S4, the controller 2 switches “off” the first electromagnetic clutch based on the first sensor being switched “off”, and switches “off” the second electromagnetic clutch based on the second sensor being switched “off”.

In more detail, in step S5, the controller 2 determines whether or not the first sensor is switched from “on” to “off”, and whether or not the second sensor is switched from “on” to “off”. If the first sensor is switched from “on” to “off”, the controller 2 switches “off” the first electromagnetic clutch after the first predetermined time period has elapsed from when the first sensor has been switched “off”. If the second sensor is switched from “on” to “off”, the controller 2 switches “off” the second electromagnetic clutch after a third predetermined time period has elapsed from when the second sensor has been switched “off”.

After step S5, the controller 2 causes the main motor M1 to rotate in the reverse direction after stopping the main motor M1 (S6). After step S6, the controller 2 switches “on” the first electromagnetic clutch until the first sensor is switched “on” (S7).

In more detail, in step S7, the controller 2 switches “on” the first electromagnetic clutch and then determines whether the first sensor is switched from “off” to “on”. If it is determined that the first sensor is switched “on”, the controller 2 switches “off” the first electromagnetic clutch after a second predetermined time period has elapsed from when the first sensor has been switched “on”.

After step S7, the controller 2 switches “on” the second electromagnetic clutch until the second sensor is switched “on” (S8). In more detail, in step S8, the controller 2 switches “on” the second electromagnetic clutch and then determines whether the second sensor is switched from “off” to “on”. If it is determined that the second sensor is switched “on”, the controller 2 switches “off” the second electromagnetic clutch after a fourth predetermined time period has elapsed from when the second sensor has been switched “on”. After step S8, the controller 2 ends the present process.

If it is determined that the first sensor is not “on” in step S2 (No), i.e., the second sensor is “on” and the first sensor is “off”, the controller 2 causes the main motor M1 to rotate in the forward direction (S9) and then switches the second electromagnetic clutch “on” (S10). After step S10, the controller 2 switches “off” the second electromagnetic clutch based on the second sensor being switched “off” (S11). The process of step S11 is the same as the process of controlling the second electromagnetic clutch in step S5; therefore, the description thereof will be omitted.

After step S11, the controller 2 proceeds to the process of step S6.

If it is determined that the second sensor is not “on” in step S1 (No), the controller 2 does not execute the first forward rotation process and the second forward rotation process and proceeds to the process of step S6.

Here, as described above, the image forming apparatus 1 may be in either the standby state, the monochrome printing mode or the color printing mode. In the standby state, all of the development rollers 61 are located in the spaced position; therefore, the first sensor and the second sensor will both be “on”. In the monochrome printing mode, only the development roller 61K is located in the contact position; thus, the first sensor will be “off” and the second sensor will be “on”.

In the color printing mode, all of the development rollers 61 are located in the contact position; thus, the first sensor and the second sensor will both be “off”. Therefore, there is no situation in the image forming apparatus 1 where the first sensor is “on” and the second sensor is “off”. The state of the sensors are both “off” when it is determined “no” in step S1.

Next, operation of the spacing cam 150 during execution of the initial position return process will be described.

If the first sensor and the second sensor are both “on” upon start of the initial position return process, the spacing cams 150 of the respective colors are usually located in the second phase. However, at least one spacing cam 150 may be misaligned from the second phase by an unintentional external force. When the initial position return process is executed in this situation, the spacing cams 150 of the respective colors move from the present phase to the first phase by the first forward rotation process and the second forward rotation process. Subsequently, the spacing cams 150 of the respective colors move from the first phase to the second phase by the first reverse rotation process and the second reverse rotation process. This allows the spacing cams 150 of the respective colors to be located in the second phase as the initial position.

If the first sensor is “off”' and the second sensor is “on” upon start of the initial position return process, the spacing cam 150K is usually located in the first phase and the spacing cams 150Y, 150M, 150C are usually located in the second phase. However, one of the spacing cams 150Y, 150M, 150C may be misaligned from the second phase by an unintentional external force. When the initial position return process is executed in this situation, the spacing cams 150Y, 150M, 150C move from the present phase to the first phase by the second forward rotation process. Subsequently, the spacing cams 150 of the respective colors move from the first phase to the second phase by the first reverse rotation process and the second reverse rotation process. This allows the spacing cams 150 of the respective colors to be located in the second phase as the initial position.

If the first sensor and the second sensor are both “off” upon start of the initial position return process, the spacing cams 150 of the respective colors are usually located in the first phase. When the initial position return process is executed in this situation, the spacing cams 150 of the respective colors move from the first phase to the second phase by the first reverse rotation process and the second reverse rotation process. This allows the spacing cams 150 of the respective colors to be located in the second phase as the initial position.

The following advantageous effects can be achieved by the present embodiment.

The wall W of the spacing cam 150 is configured to contact the corresponding cam follower 170 in the rotation direction; thus, it is possible to restrict the rotation of the spacing cam 150 and the spacing cam 150 can thereby be restrained from rotating excessively.

The first wall W1 protruding from the first surface F1 is configured to contact the cam follower 170K; thus, the spacing cam 150K can be restrained from rotating excessively in a direction in which the inclined surface F3 moves away from the cam follower 170K located in the non-pushing position. Accordingly, for example, the spacing cam 150K pushed by the slider 300 can be restrained from rotating excessively.

The second wall W2 protruding from the second surface F2 is configured to contact the cam follower 170; thus, the spacing cam 150 can be restrained from rotating excessively in a direction in which the inclined surface F3 moves away from the cam follower 170 located in the pushing position. Accordingly, the cam follower 170 can be restrained from falling off the second surface F2.

The spacing cam 150K is configured to rotate from a position in which the first wall W1 contacts the cam follower 170K to a position in which the second wall W2 contacts the cam follower 170K; thus, the spacing cam 150K can be rotated within a predetermined range.

Since the angle θ1 formed by the first straight line L1 and the second straight line L1 is equal to or smaller than 180 degrees, the spacing cam 150K can be rotated in a space-saving manner.

Since rotation of the cam follower 170 is restricted by a stopper 530, the spacing cam 150 can be more reliably restrained from rotating excessively when the wall W contacts the cam follower 170.

The rib 156 overlapping the cam portion 153 as viewed in the rotation axis direction is configured to contact the contact surface 15A of the metal plate 15; thus, a force exerted on the cam portion 153 from the cam follower 170 can be efficiently received by the contact surface 15A through the rib 156. This increases friction between the rib 156 and the contact surface 15A and can restrain the spacing cams 150 from being misaligned by an external force. Further, since the cam portion 153 and the rib 156 overlap each other as viewed in the rotation axis direction, the spacing cam 150 can be restrained from tilting by a force exerted on the cam portion 153 from the cam follower 170.

The inclined surface F3 of the cam portion 153 and the rib 156 are configured to overlap each other as viewed in the rotation axis direction; thus, the reaction force exerted on the cam portion 153 from the cam follower 170 can be efficiently received by the contact surface 15A through the rib 156 when the cam follower 170 is being pushed by the inclined surface F3 of the cam portion 153.

Since the rib 156 has an arcuate shape, the rib 156 can be arranged in a space-saving manner.

Since a central angle of the rib 156 is equal to or smaller than 180 degrees, the rib 156 can be arranged in a more space-saving manner.

Since the spacing cam 150 is configured to include a reinforcement rib 157, the rigidity of the rib 156 can be increased. The reinforcement rib 157 has a surface F11 that is inclined in such a manner that the closer to the rotation axis X1, the farther from the contact surface 15A; thus, rotational resistance of the rotating cam 150 can be restrained from becoming too large.

Since the idle gear 124 is biased toward the metal plate 15 by a leaf spring 600, a rotational resistance is applied to the idle gear 124 to restrain the spacing cam 150K from being misaligned by an external force.

The idle gear 124 is configured to engage the gear teeth of the spacing cam 150K; thus, backlash effects are reduced compared to an alternative configuration in which another gear is provided between the idle gear and the spacing cam and the spacing cam 150K can thereby be further restrained from being misaligned.

By forming the supporting member that supports the spacing cam 150 with a metal plate 15, the strength of the supporting member can be increased.

Since the cam follower 170 which is a member located closer than the spacing cam 150 to the development roller 61 is directly detected by the sensor, the position of the development roller 61 can be determined more accurately compared to, for example, an alternative structure in which the spacing cam is directly detected by a sensor.

The cam follower 170 located in the pushing position is configured to block light emitted from the light emitting element 4P toward the light receiving element 4R; thus, it is possible to accurately determine that the development roller 61 is located in the spaced position.

Since the light emitting element 4P and the light receiving element 4R are located closer than the cam portion 153 to the rotation axis X1 of the spacing cam 150, the sensor can be arranged in a space-saving manner.

Since the process to be executed is selected from the first forward rotation process and the first reverse rotation process based on the detection result of the first sensor upon start of the initial position return process and executed, only the first reverse rotation process needs to be executed if, for example, the projection 174 of the first sensor is undetectable; thus, it is possible to reduce the time it takes to execute the initial position return process.

Since the first forward rotation process is not executed if the first sensor is “off” and the second sensor is “on” upon start of the initial position return process, it is possible to reduce the time it takes to execute the initial position return process.

Since the first forward rotation process and the second forward rotation process are not executed if the first sensor is “off” and the second sensor is “off” upon start of the initial position return process, it is possible to reduce the time it takes to execute the initial position return process.

Since the first forward rotation process and the second forward rotation process are executed in such a manner that their execution periods overlap, it is possible to reduce the time it takes to execute the initial position return process compared to an alternative configuration in which the first forward rotation process and the second forward rotation process are executed, for example, in such a manner that their execution periods do not overlap.

Since the first reverse rotation process and the second reverse rotation process are executed in such a manner that their execution periods do not overlap, it is possible to reduce the load on the main motor M1 compared to an alternative configuration in which the first reverse rotation process and the second reverse rotation process are executed in such a manner that their execution periods overlap. In more detail, the cam portion 153 pushes the cam follower 170 in the first reverse rotation process and the second reverse rotation process; thus, the load on the main motor M1 is increased if the first reverse rotation process and the second reverse rotation process are executed in such a manner that their execution periods overlap, whereas, the load on the main motor M1 can be reduced if the first reverse rotation process and the second reverse rotation process are executed in such a manner that their execution periods do not overlap.

Since the angle from the first phase to the second phase is equal to or smaller than 180 degrees, the spacing cam can be rotated in a space-saving manner.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

The color of toner contained in the second development cartridge is not limited to cyan and may be any color other than black.

The development roller may move from the spaced position to the contact position when the cam follower pushes the development cartridge.

The wall may include only the first wall.

The spring that presses the cam follower is not limited to the coil spring and may, for example, be a leaf spring, a wire spring, etc.

The supporting member is not limited to the metal plate 15 and may, for example, be a frame made of plastic.

The rib may overlap the second surface as viewed in the rotation axis direction.

The rib may not have an arcuate shape and may, for example, have a polygonal shape.

The number of reinforcement ribs is not limited to three and at least one reinforcement rib is all that is required.

A gear may be provided between the idle gear and the rotating cam.

The sensor is not limited to the photo interrupter and may, for example, be a photo reflector or the like.

The rotating cam may comprise a to-be-detected portion.

Although the fixing-driving gear train GT2 is configured to transmit the driving force of the main motor M1 to the heating roller 81A (heating member 81) in the above-described embodiment, the fixing-driving gear train may be configured to transmit the driving force of the main motor to the pressure member. Further, the fixing-driving gear train may be configured to transmit the driving force of the main motor to both the heating member and the pressure member.

Although the heating member 81 comprises the heating roller 81A in the above-described embodiment, the heating member may be configured to comprise an endless belt. Although the pressure member 82 is a pressure roller in the above-described embodiment, the pressure member may, for example, comprise an endless belt and a pad that nips the belt in combination with the heating member.

Although transmission and interruption of the driving force to the fixing device 80 is switched by the moving gear 131 in the above-described embodiment, transmission and interruption of the driving force to the fixing device may, for example, be switched by an electromagnetic clutch.

Although the nip pressure adjusting cam 230 is configured to change the nip pressure of the heating member 81 and the pressure member 82 to two levels including the low nip pressure and the high nip pressure in the above-described embodiment, the nip pressure adjusting cam may be configured to be capable of changing the nip pressure to three or more levels. In other words, the second nip pressure may include a plurality of nip pressures. Further, the heating member and the pressure member may be spaced apart in the first nip pressure.

Although the nip pressure adjusting cam 230 is configured to change the nip pressure by moving the pressure member 82 in the above-described embodiment, the nip pressure adjusting cam may, for example, be configured to change the nip pressure by moving the heating member instead of the pressure member. Further, the nip pressure adjusting cam may be configured to change the nip pressure by moving both the heating member and the pressure member.

Although the spacing cams 150Y, 150M, 150C are integrally controlled in the above-described embodiment, the spacing cams 150Y, 150M, 150C may, for example, be separately controllable.

Although the stopper 530 is shaped as a wall in the above-described embodiment, the stopper may be shaped as a rod. Although the stopper 530 is integrally formed with the cover wall 510 in the above-described embodiment, the stopper may, for example, be a member fixed to the cover wall.

Further, for example, the stopper may not be provided, and the rotation of the cam follower may be restricted by forming the cross-sectional shapes of the portions of the boss of the cam and the slide shaft of the cam follower, that are to be engaged, into a triangular shape, a quadrilateral shape, a D-shape, an elliptical shape, etc.

Although the photosensitive drum 50 is rotatably supported by the drawer 55 in the above-described embodiment, the photosensitive drum may, for example, be removably attached to the drawer. Specifically, the image forming apparatus may include a drum cartridge comprising the photosensitive drum and the drum cartridge may be removably attached to the drawer. Further, the image forming apparatus may comprise a cartridge comprising the photosensitive drum and the development roller and formed as if the drum cartridge and the development cartridge 60 of the above-described embodiment were one unit, and this cartridge may be removably attached to the drawer.

Although the image forming apparatus 1 is a color printer capable of forming a multicolor image in the above-described embodiment, the image forming apparatus may, for example, be a monochrome printer capable of forming only a monochrome image. Further, the image forming apparatus may, for example, be a copying machine or a multifunction machine.

The elements described in the above embodiment and its modifications may be implemented selectively and in combination.

What is claimed is:

1. An image forming apparatus, comprising:
a photosensitive drum;
a development cartridge comprising a development roller that is movable between a contact position in which the development roller is in contact with the photosensitive drum and a spaced position in which the development roller is spaced apart from the photosensitive drum;
a motor rotatable in a forward direction and in a reverse direction;
a rotating cam rotatable in a forward direction and in a reverse direction in response to receiving a driving force of the motor; and
a cam follower configured to move in a direction of a rotation axis of the rotating cam in response to rotation of the rotating cam and to push the development cartridge to move the development roller between the contact position and the spaced position,
wherein the rotating cam includes a wall configured to contact the cam follower in a direction of rotation of the rotating cam to restrict the rotation of the rotating cam.

2. The image forming apparatus according to claim 1,
wherein the cam follower is movable between a pushing position in which the cam follower pushes the development cartridge to locate the development roller in the spaced position, and a non-pushing position in which the cam follower locates the development roller in the contact position,
wherein the rotating cam comprises:
a first surface configured to locate the cam follower in the non-pushing position;
an inclined surface extending obliquely from the first surface and configured to push the cam follower in the direction of the rotation axis away from the first surface to move the cam follower from the non-pushing position to the pushing position; and
a second surface connected to the inclined surface and configured to retain the cam follower in the pushing position, and
wherein the wall includes a first wall protruding from the first surface.

3. The image forming apparatus according to claim 2, wherein the wall includes a second wall protruding from the second surface.

4. The image forming apparatus according to claim 3,
wherein the first wall, the first surface, the inclined surface, the second surface and the second wall are located in this order in the direction of rotation of the rotating cam, and the rotating cam is rotatable from a position in which the first wall contacts the cam follower to a position in which the second wall contacts the cam follower.

5. The image forming apparatus according to claim 4,
wherein the first wall has a first side surface that contacts the cam follower,
wherein the second wall has a second side surface that contacts the cam follower, and
wherein an angle formed by a first straight line connecting the rotation axis of the rotating cam and the first side surface, and a second straight line connecting the rotation axis of the rotating cam and the second side surface is equal to or smaller than 180 degrees as viewed in the direction of the rotation axis.

6. The image forming apparatus according to claim 4,
wherein the motor rotates in the forward direction during printing, and
wherein the cam follower is configured to move in a direction from the second surface toward the first surface by way of the inclined surface relative to the rotating cam in response to rotation of the motor in the forward direction.

7. The image forming apparatus according to claim 6, wherein the cam follower is configured to move in a direction from the first surface toward the second surface by way of the inclined surface relative to the rotating cam in response to rotation of the motor in the reverse direction.

8. The image forming apparatus according to claim 3, wherein the cam follower comprises:
a slide shaft movable in the direction of the rotation axis;
an arm extending from the slide shaft in a direction perpendicular to the direction of the rotation axis; and
a pin extending from the arm in the direction of the rotation axis and configured to push the development cartridge.

9. The image forming apparatus according to claim 8, wherein the arm is contactable with the first wall.

10. The image forming apparatus according to claim 8, wherein the arm is contactable with the second wall.

11. The image forming apparatus according to claim 2, further comprising a spring that biases the cam follower toward the non-pushing position.

12. The image forming apparatus according to claim 1, further comprising a stopper configured to restrict the cam follower from rotating in the direction of rotation of the rotating cam.

13. The image forming apparatus according to claim 12, further comprising a cover configured to cover the rotating cam, wherein the cover includes the stopper.
